(19) United States
(12) Patent Application Publication
(10) Pub. No.: US 2026/0260998 A1
(43) Pub. Date: Sep. 3, 2026

(54) ELECTRIC RIDING LAWN MOWER AND BATTERY PACK

(71) Applicant: BLACK & DECKER INC., New Britain, CT (US)

(72) Inventors: Abhisheka MOTURU, Pikesville, MD (US); Elizabeth WINK, Baltimore, MD (US); Colin BOICE, Towson, MD (US); Jesse Ramon ESCOBEDO, Rockville, MD (US); Jason F. BUSSCHAERT, Bel Air, MD (US); Samuel B. ESHELMAN, Jr., Fallston, MD (US)

(21) Appl. No.: 18/995,623

(22) PCT Filed: Jul. 21, 2023
(86) PCT No.: PCT/US2023/070782

§ 371 Date: Jan. 16, 2025

Related U.S. Application Data
(60) Provisional application No. 63/391,218, filed on Jul. 21, 2022.

(51) Int. Cl. H01M 50/264; A01D 69/02; B60L 50/60; H01M 50/244; H01M 50/249; H01M 50/256

(52) U.S. Cl. CPC H01M 50/264; A01D 69/02; B60L 50/66; H01M 50/244; H01M 50/249; H01M 50/256

(57) ABSTRACT

A combination of an electric power tool, for example a riding lawn mower, and a battery pack for powering the power tool. The power tool includes a compartment for receiving at least one battery pack. The combination includes a latching system for holding the battery pack in the compartment. The compartment includes a handle guidance/latching element that cooperates with the battery pack and the battery pack includes a handle that cooperates with the handle guidance/latching element.

### RELATED APPLICATIONS

This application claims the benefit of and priority to PCT Patent Application No.

PCT/US 2023/070782, filed Jul. 21, 2023, titled “Electric Riding Lawn Mower and Battery Pack,” which claims priority to and the benefit of U.S. Provisional Patent Application No. 63/391,218, filed Jul. 21, 2022, titled “Electric Riding Lawn Mower and Battery Pack,” all of which are incorporated by reference herein in their entireties.

### TECHNICAL FIELD

This application relates to an electric riding lawn mower and a battery pack to provide power to the lawn mower. In one implementation, the riding lawn mower includes at least one battery pack received in a battery pack compartment. The at least one battery pack provides power to a drive system and/or a lawn cutting system.

### SUMMARY

An aspect of the present invention may include a battery pack for powering an electric power tool.

An example embodiment of the aforementioned battery may include a housing, a handle attached to the housing, a lever, the lever including a first arm having a latch engaging end and a second arm having an actuation button engaging end, an actuation button positioned for engagement with the actuation button engaging end of the lever, and a catch forming an opening in the handle positioned to receive the latch engaging end of the lever.

The aforementioned example embodiment may further include a battery pack, wherein the handle includes an internal cavity and the lever is positioned within the internal cavity.

The aforementioned example embodiment may further include a battery pack, wherein rotation of the lever about a pivot axis moves the latch engaging end of the lever into the catch.

The aforementioned example embodiment may further include a battery pack, further including an actuation button spring between an interior surface of the actuation button and an interior surface of an internal cavity of the handle that applies a force against the actuation button to move the actuation button out of the internal cavity.

The aforementioned example embodiment may further include a battery pack, further including a lever spring between a surface of the actuation button engaging end of the lever and an interior surface of an internal cavity of the handle that applies a force against the actuation button engaging end of the lever to move the latch engaging end of the lever into the internal cavity.

The aforementioned example embodiment may further include a battery pack, wherein when a force is applied to the actuation button opposed to the actuation button spring the actuation button moves into the internal cavity, the lever rotates about a pivot axis and the latch engaging end of the lever moves into the catch.

The aforementioned example embodiment may further include a battery pack, wherein the handle is a discrete component and is attached to the housing by fasteners.

The aforementioned example embodiment may further include a battery pack, wherein the handle is integrally formed with the housing.

The aforementioned example embodiment may further include a battery pack, wherein the housing includes opposing sides and a bottom coupling the opposing sides and a groove on each of the opposing sides of the housing and groove on a bottom of the housing,

The aforementioned example embodiment may further include a battery pack, wherein the handle has a generally L-shaped configuration and includes a first leg extending along a top side of the housing and a second leg extending along a rear side of the housing, wherein the first leg includes the catch.

An aspect of the present invention may include a combination of an electric power tool and a battery pack for powering the electric power tool.

An example embodiment of the aforementioned combination may include a power tool including a compartment for receiving a battery pack, the compartment including a space generally defined by a front wall, a rear wall, a top wall, a bottom wall, a left side wall and a right side wall, wherein the battery pack is received in the compartment in a direction from the rear wall towards the front wall and the top wall includes a groove and the bottom wall includes a rail, a battery pack including a housing, the housing including a handle on a top side and a groove on a bottom side, the handle opposed to the groove, the handle received in the compartment groove and the compartment rail received in the battery pack groove.

The aforementioned example embodiment may further include a combination wherein the handle includes a catch for receiving a latch and the compartment includes a latch received in the catch.

The aforementioned example embodiment may further include a combination further comprising an actuation button to remove the latch from the catch.

The aforementioned example embodiment may further include a combination further comprising a lever positioned within the handle, the lever including a latching engaging end and an actuation button engaging end, wherein upon applying a force to the actuation button, the actuation button engages the actuation button engaging end of the lever forcing the lever to rotate about a pivot axis and forcing the latch engaging end of the lever to engage the latch and force the latch out of the catch.

The aforementioned example embodiment may further include a combination further comprising a handle guidance/latching element attached to the top wall, the handle guidance/latching element include a pair of rails that form the compartment groove and the latch.

The aforementioned example embodiment may further include a combination wherein the latch includes a crossbar member, a first leg member attached to and extending generally perpendicularly to a first end of the crossbar member and a second leg member attached to and extending generally perpendicularly to a second end of the crossbar member, wherein the first leg member and the second leg member are generally parallel to each other.

The aforementioned example embodiment may further include a combination wherein the latch is rotatably coupled to the handle guidance/latching element by a pair of pivot arms, wherein each pivot arm of the pair of pivot arms extends from an associated leg member presenting a pivot arm on each side of the compartment groove.

The aforementioned example embodiment may further include a combination wherein the pivot arms are held in place by an arm holddown that allows the latch to rotate about an axis of the pivot arm that is generally perpendicular to the leg member.

The aforementioned example embodiment may further include a combination further comprising a coil spring located between a handle guidance/latching element housing and a second end of each of the leg members.

The aforementioned example embodiment may further include a combination wherein the handle guidance/latching element housing includes an opening associated with the groove that provides passage from an inner surface of the handle guidance/latching element and an outer surface of the handle guidance/latching element.

### BRIEF DESCRIPTION OF THE DRAWINGS

FIG. 1 is a front elevation view of an example riding lawn mower.

FIG. 2 is a rear elevation view of the lawn mower of FIG. 1.

FIG. 3 is a rear, right side isometric view of the lawn mower of FIG. 1.

FIG. 4 is a rear, left side isometric view of the lawn mower of FIG. 1.

FIG. 5 is a left side, elevation view of an example battery pack.

FIG. 6 is a right side, elevation view of the battery pack of FIG. 5.

FIG. 7 is a rear side, elevation view of the battery pack of FIG. 5.

FIG. 8 is a front side, elevation view of the battery pack of FIG. 5.

FIG. 9 is a top side, plan view of the battery pack of FIG. 5.

FIG. 10 is a bottom side, plan view of the battery pack of FIG. 5.

FIG. 11 is a top, rear, left side, isometric view of the battery pack of FIG. 5.

FIG. 12 is a top, rear, right side, isometric view of the battery pack of FIG. 5.

FIG. 13 is a top, front, left side, isometric view of the battery pack of FIG. 5.

FIG. 14 is a top, front, right side isometric view of the battery pack of FIG. 5.

FIG. 15 is a bottom, rear, right side isometric view of the battery pack of FIG. 5.

FIG. 16 is a bottom, rear, left side isometric view of the battery pack of FIG. 5.

FIG. 17 is a bottom, front, left side isometric view of the battery pack of FIG. 5.

FIG. 18 is a bottom, front, right side isometric view of the battery pack of FIG. 5.

FIG. 19 is a right side, elevation view of an example handle of the battery pack of FIG. 6 in which the pack removal mechanism is in an unactuated state and the right side housing removed.

FIG. 20 is a detail view of the battery pack handle of FIG. 19.

FIG. 21 is a top, rear, right side isometric view of the battery pack handle of FIG. 19.

FIG. 22 is a detail view of the battery pack handle of FIG. 21.

FIG. 23 is a right side, elevation view of the battery pack of FIG. 6 in which the pack removal mechanism is in an actuated state.

FIG. 24 is a top, rear, right side isometric view of the battery pack of FIG. 23.

FIG. 25 is a right side, elevation view of the battery pack handle of FIG. 23 with the right side housing removed.

FIG. 26 is a detail view of the battery pack handle of FIG. 25.

FIG. 27 is a top, rear, right side isometric view of the battery pack handle of FIG. 25.

FIG. 28 is a detail view of the battery pack handle of FIG. 27.

FIG. 29 is a top, plan view of the lawn mower of FIG. 1 and the battery pack of FIG. 5 prior to insertion of the battery pack in the lawn mower.

FIG. 30 is a rear, elevation view the lawn mower and the battery pack of FIG. 29 prior to insertion of the battery pack in the lawn mower.

FIG. 31 is a top, rear, right side isometric view of the lawn mower and the battery pack of FIG. 29 prior to insertion of the battery pack in the lawn mower.

FIG. 32 is a rear, elevation view the lawn mower and the battery pack of FIG. 29 after insertion of the battery pack in the lawn mower.

FIG. 33 is a top, rear, right side isometric view of the lawn mower and the battery pack of FIG. 29 after insertion of the battery pack in the lawn mower in which a portion of the lawn mower is illustrated as transparent.

FIG. 34 is a detail, section view at section lines A-A of FIG. 32.

FIG. 35 is a detail view of FIG. 32 of the battery pack inserted in the lawn mower.

FIG. 36 is a top, rear, right side isometric view the battery pack of FIG. 12 inserted in a battery compartment of the lawn mower with a portion of the lawn mower removed.

FIG. 37 is a detail view of FIG. 36 of the battery pack inserted in the battery compartment.

FIG. 38 is a detail, section view at section lines B-B of FIG. 32.

FIG. 39 is a detail, section view at section lines C-C of FIG. 32.

FIG. 40 is top, rear, right side isometric view of an example battery compartment and the battery pack of FIG. 12 inserted therein.

FIG. 41 is the battery compartment and battery pack of FIG. 40 with selected side walls removed and a battery compartment door included.

FIG. 42 is a top, plan view of FIG. 41.

FIG. 43 is a detail, section view at section lines D-D of FIG. 42.

FIG. 44 is a top, rear, right side isometric view of a second example battery pack partially inserted into the battery pack compartment of the lawn mower in which a portion of the lawn mower is illustrated as transparent.

FIG. 45 is a top, rear, right side isometric view of five example battery packs inserted into the battery pack compartment of the lawn mower in which a portion of the lawn mower is illustrated as transparent.

FIG. 46 is a rear, elevation view of the lawn mower and battery packs of FIG. 45.

FIG. 47 is a rear, elevation view of five example battery packs inserted in an example battery pack compartment.

FIG. 48 is a top, rear, right side isometric view of an example battery pack guidance and latching element of the lawn mower battery pack interface in which all latches are in a latched position.

FIG. 49 is a bottom, front, right side isometric view of the battery pack guidance and latching element of FIG. 48.

FIG. 50 is a top, plan view of the battery pack guidance and latching element of FIG. 48.

FIG. 51 is bottom plan view of the battery pack guidance and latching element of FIG. 48.

FIG. 52 is a rear, elevation view of the battery pack guidance and latching element of FIG. 48.

FIG. 53 is a front, elevation view of the battery pack guidance and latching element of FIG. 48.

FIG. 54 is a section view of the battery pack guidance and latching element of FIG. 48 along section lines E-E.

FIG. 55 is a section view of the battery pack guidance and latching element of FIG. 48 along section lines F-F.

FIG. 56 is a top, rear, right side isometric view of the example battery pack guidance and latching element of the lawn mower battery pack interface in which one of the latches is in an unlatched position.

FIG. 57 is a top, plan view of the battery pack guidance and latching element of FIG. 56.

FIG. 58 is bottom plan view of the battery pack guidance and latching element of FIG. 56.

FIG. 59 is a rear, elevation view of the battery pack guidance and latching element of FIG. 56.

FIG. 60 is a front, elevation view of the battery pack guidance and latching element of FIG. 56.

FIG. 61 is a section view of the battery pack guidance and latching element of FIG. 56 along section lines G-G.

FIG. 62 is a section view of the battery pack guidance and latching element of FIG. 56 along section lines H-H.

FIG. 63 is a top, rear, right side isometric view of an example battery pack inserted in an example battery pack compartment.

FIG. 64 is a top, plan view of FIG. 63.

FIG. 65 is a rear, elevation view of FIG. 63.

FIG. 66 is a right side elevation view of FIG. 63.

FIG. 67 is a top, front, left side isometric view of FIG. 63.

FIG. 68 is a section view along lines I-I of FIG. 65.

FIG. 69 is a top, rear, left side isometric view of the battery pack of FIG. 11 and the guidance/latching element of FIG. 56 illustrating the battery pack prior to mating with the lawn mower or after unmating with the lawn mower.

FIG. 70 is a top, rear, left side isometric view of the battery pack of FIG. 11 and the guidance/latching element of FIG. 56 illustrating the battery pack mated to the lawn mower and the latch received in the battery pack.

FIG. 71 is a top, elevation view of FIG. 70.

FIG. 72 is a section view along lines J-J of FIG. 65.

FIG. 73 is a detail view of FIG. 72.

FIG. 74 is a top, rear, left side isometric view of the battery pack of FIG. 11 and the guidance/latching element of FIG. 56 illustrating the battery pack mated to the lawn mower and the latch removed from the battery pack.

FIG. 75 is a top, elevation view of FIG. 74.

FIG. 76 is a section view along lines K-K of FIG. 75.

FIG. 77 is a detail view of FIG. 76.

FIG. 78 is a view of an example electric riding lawn mower coupled to an example battery charger.

FIG. 79 is an isometric view of an example battery charger for an electric riding lawn mower.

FIG. 80 is a side view of an example supply hose/nozzle/connector of the battery charger of FIG. 79.

FIG. 81 is a right side view of the nozzle/connector of the battery charger of FIG. 79.

FIG. 82 is a left side view of the nozzle/connector of the battery charger of FIG. 79.

FIG. 83 is a top side view of the nozzle/connector of the battery charger of FIG. 79.

FIG. 84 is a bottom side view of the nozzle/connector of the battery charger of FIG. 79.

FIG. 85 is a front side view of the nozzle/connector of the battery charger of FIG. 79.

FIG. 86 is a rear side view of the nozzle/connector of the battery charger of FIG. 79.

FIG. 87 is a rear, right side isometric view of the nozzle/connector of the battery charger of FIG. 79.

FIG. 88 is a front, right side isometric view of the nozzle/connector of the battery charger of FIG. 79.

FIG. 89 is a right side view of the nozzle/connector of the battery charger of FIG. 79 in which a right side portion of a housing of the nozzle has been removed.

FIG. 90 is a detail view of FIG. 89.

FIG. 91 is a front elevation view of FIG. 90.

FIG. 92 is a side elevation view of FIG. 90 in which a plug of the connector has been removed.

FIG. 93 is a front elevation view of FIG. 92 in which a terminal assembly has been remove.

FIG. 94 is front, right side isometric view of FIG. 93.

FIG. 95 is a front, left side isometric view of plug assembly of the nozzle/connector of FIG. 81.

FIG. 96 is a rear, left side isometric view of FIG. 95.

FIG. 97 is a partial section view of the nozzle/connector prior to mating with a receptacle of the lawn mower of FIG. 78.

FIG. 98 is an isometric view of the nozzle/connector of FIG. 81 mated with the receptacle of the lawn mower of FIG. 78.

FIG. 99 is a partial section view of the nozzle/connector of FIG. 81 mated with the receptacle of the lawn mower of FIG. 78.

FIG. 100 is a section view of the nozzle/connector of FIG. 81 mated with the receptacle of the lawn mower of FIG. 78.

FIGS. 101-112 illustrate an alternate embodiment of an example actuation button of the removal system.

### DETAILED DESCRIPTION

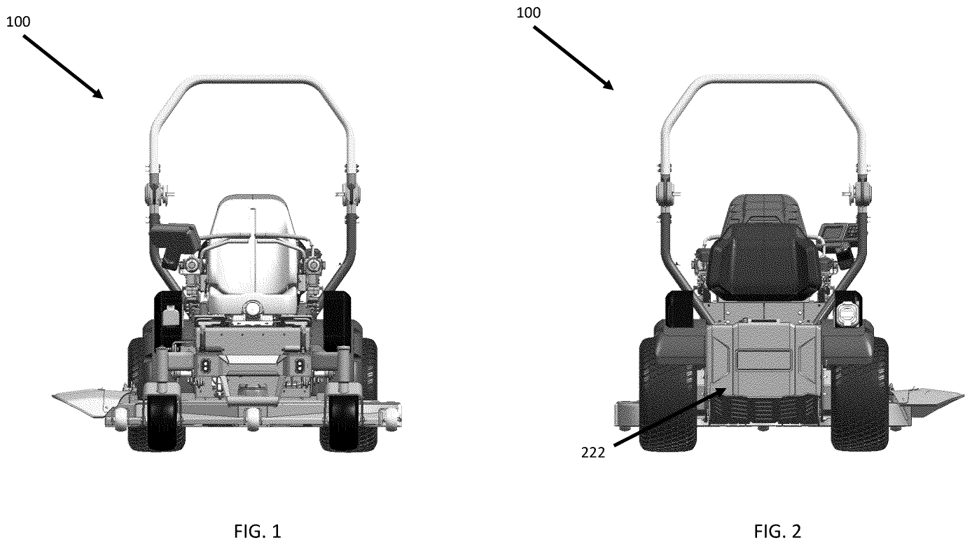

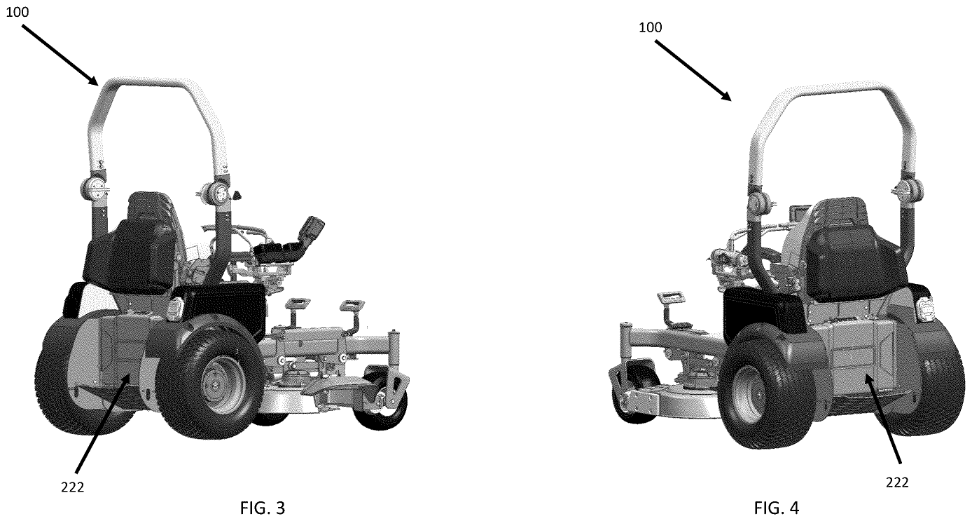

Referring to FIGS. 1-4, there is disclosed an example electric riding lawn mower. The lawn mower includes a front pair of wheels and a rear pair of wheels. The rear wheels may include an electric hub motor for driving the rear wheels. The lawn mower may include a plurality of cutting blades. The lawn mower may also include an electric motor associated with and coupled to each of the plurality of cutting blades. The lawn mower may include a motor control module for controlling the motors. The electric motors may be powered by one or more battery packs. The battery packs may be rechargeable. The battery packs may be removable. The lawn mower may include a battery pack compartment that receives and houses the removable battery packs. The lawn mower may include a battery management system. The battery management system may include a battery management/control module 116 that monitors and controls charging and discharging of the battery packs.

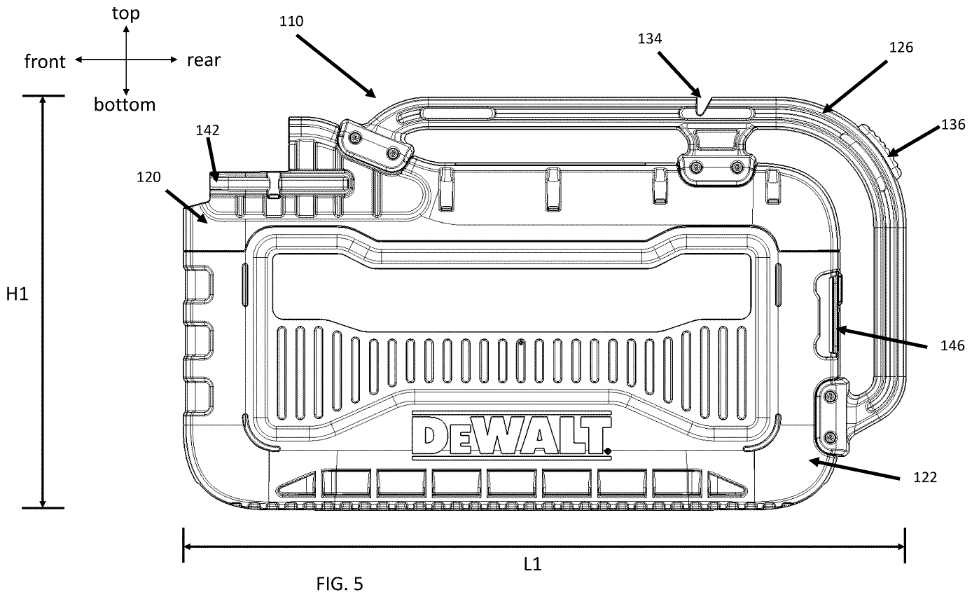

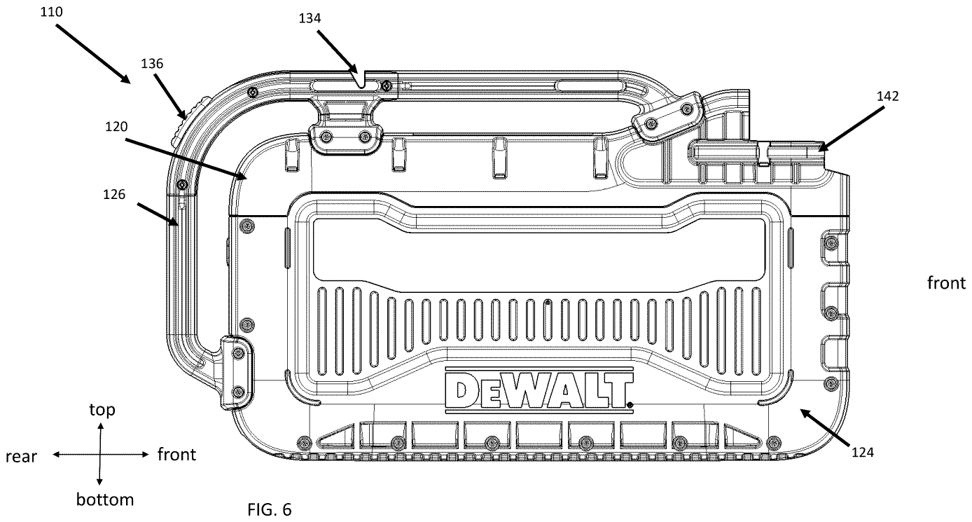

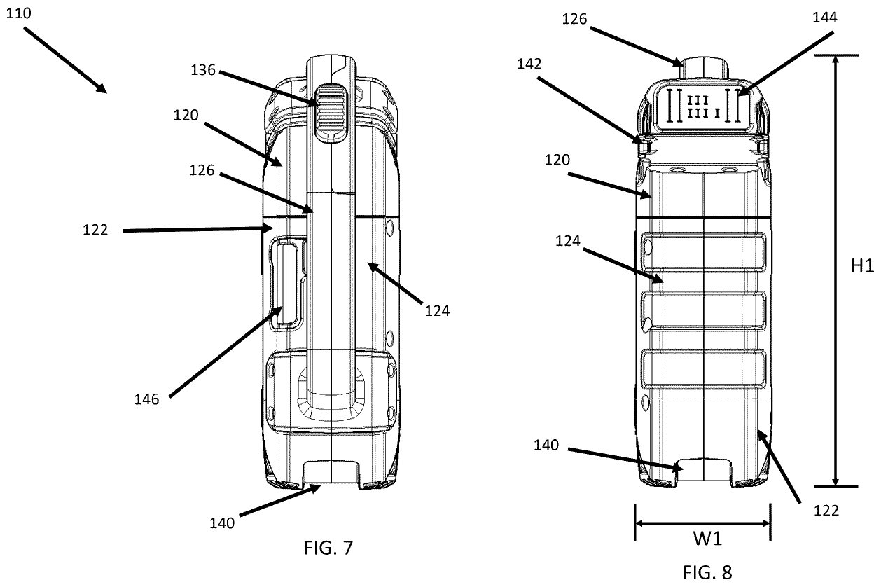

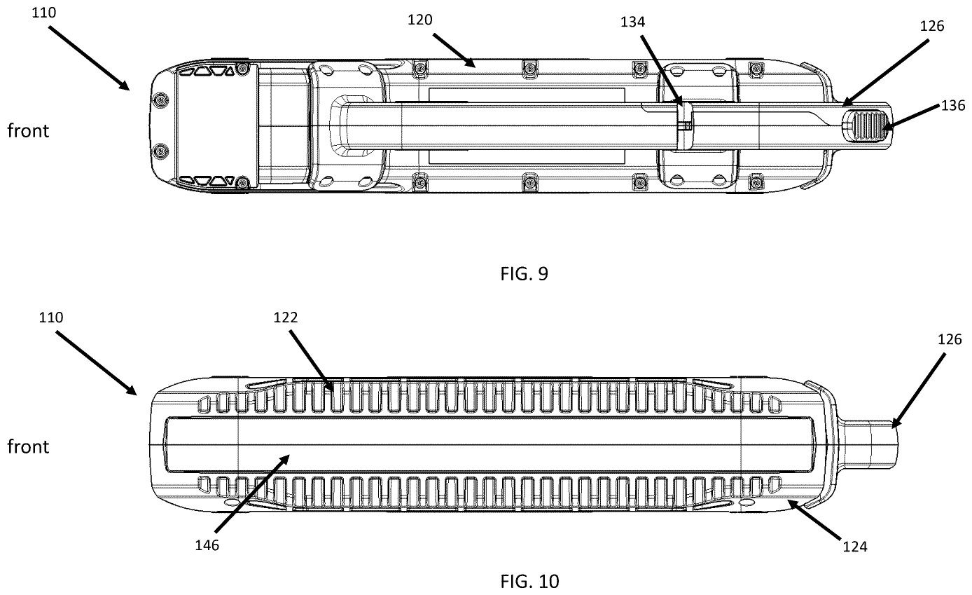

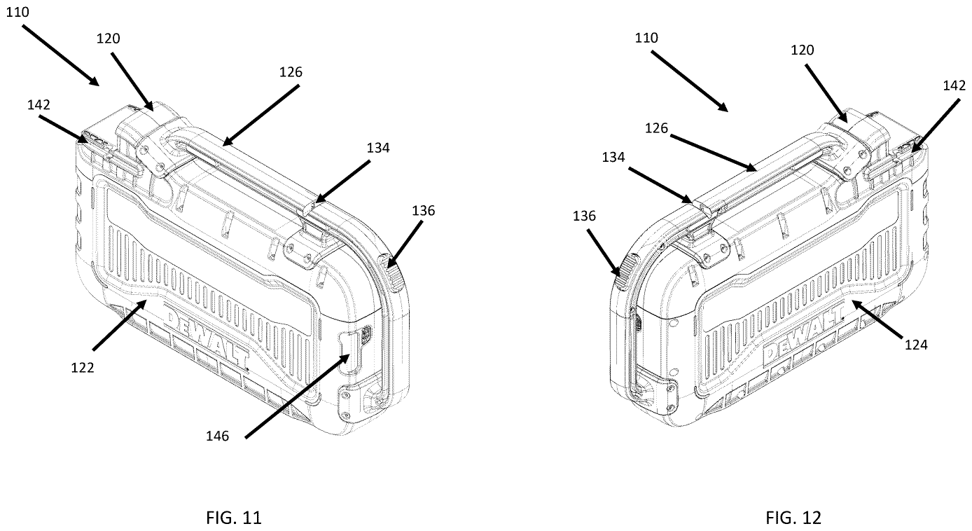

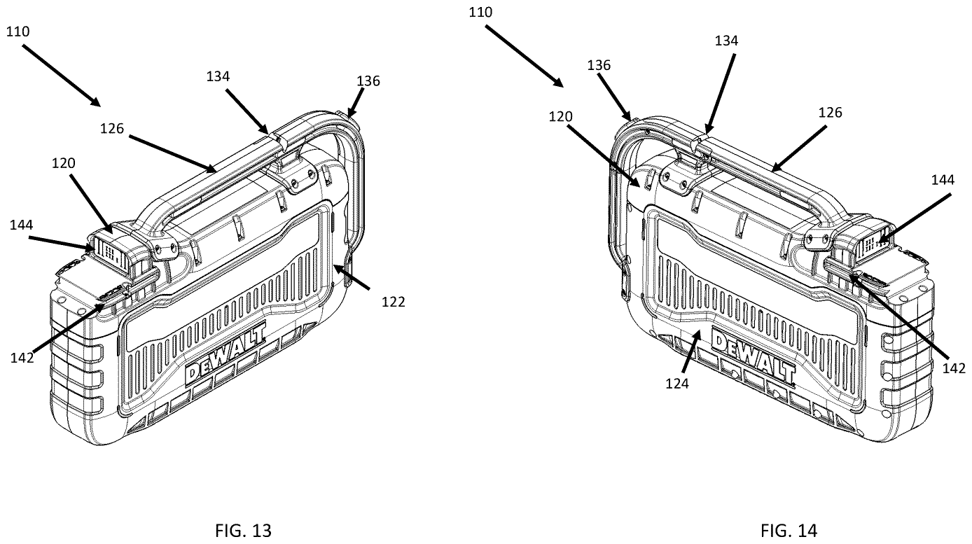

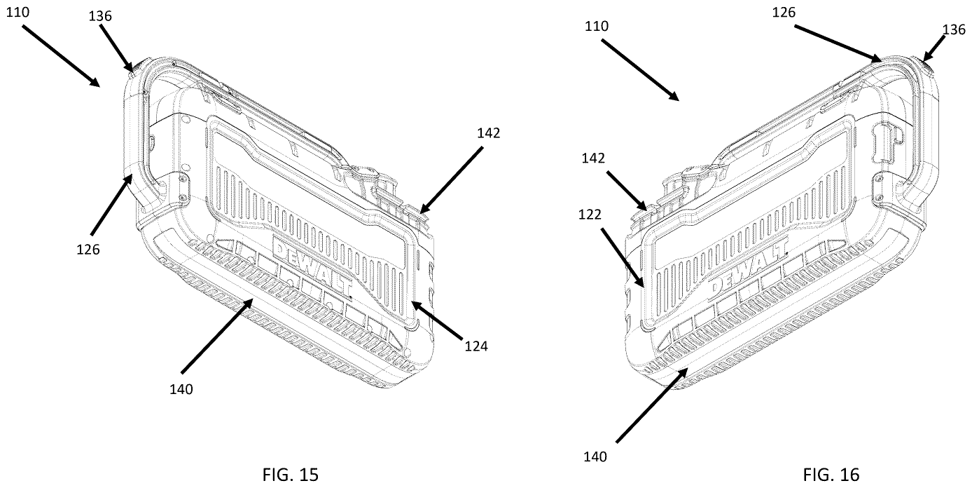

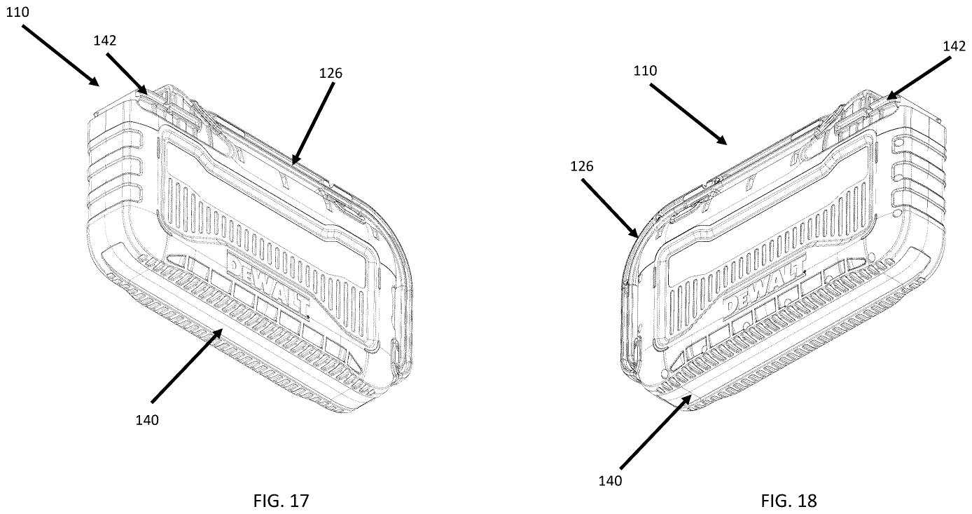

Referring to FIGS. 5-18, there is disclosed an example battery pack 110 that may be received by the lawn mower 100 and provide power to the electric motors. FIGS. 5-18 illustrate the battery pack 100 in a first state or configuration. This first state may be referred to as a default state. In the default state, a battery pack removal system is not actuated.

As illustrated, the battery pack 110 includes a housing. The housing may include a housing top portion (sometimes simply referred to as a top housing or top side portion) 120, a housing left portion (sometimes simply referred to as a left housing or left side portion or left housing portion) 122 and a housing right portion (sometimes simply referred to as a right housing or right side portion or right housing portion) 124. The top housing 120, the left housing 122 and the right housing 124 may be assembled to form an interior cavity, discussed in more detail below.

As illustrated in FIG. 5, the battery pack 110 has a length dimension L1 and a height dimension H1. As illustrated in FIG. 8, the battery pack 110 has a width dimension W1. FIGS. 5 and 6 also illustrates a context for the battery pack 110 for purposes of this patent disclosure showing a front, a rear, a top and a bottom of the battery pack 110.

The battery pack 110 may include a battery pack handle 126. The battery pack handle 126 may be integrally formed with the battery pack housing or may be a discrete element that is attached to the battery pack housing. The battery pack handle 126 may have a generally L-shaped configuration or geometry and may include a first leg 128 extending along a top side of the top housing 120 (along the length dimension L1) and a second leg 130 extending along a rear side of the top housing 120, the left housing 122 and the right housing 124 (along the height dimension H1). The handle 126 may also include a transitional portion 132 that couples the first leg 128 of the handle 126 and the second leg 130 of the handle 126.

The first leg 128 of the handle 126 may include a catch 134 that is configured to receive a corresponding latch in the lawn mower 100, as described in more detail below. The handle 126 may also include a removal system actuation button 136 that actuates a lever 138, described in more detail below, to assist in removing the battery pack 110 from the lawn mower 100. The actuation button 136 may be located in the transitional portion 132 of the handle 126.

The battery pack 110 may also include a groove or slot 140 on a bottom side of the battery pack 110. As illustrated in FIGS. 10 and 15-18, the groove 140 extends along the bottom side of the battery pack 110 (along the length dimension L1).

The top housing 120 may also include a set of side grooves 142. The side grooves 142 are configured to receive corresponding rails or tongues in the lawn mower 100, as described in more detail below.

The battery pack 110 may also include a plurality of terminal slots 144 in the top housing 120. The terminal slots 144 provide openings to enable terminals of a tool to which the battery pack 110 shall provide power to enter the battery pack housing and mate with battery pack terminals (not shown).

The battery pack 110 may also include a state of charge indicator 146 to indicate the state of charge of the battery pack 110.

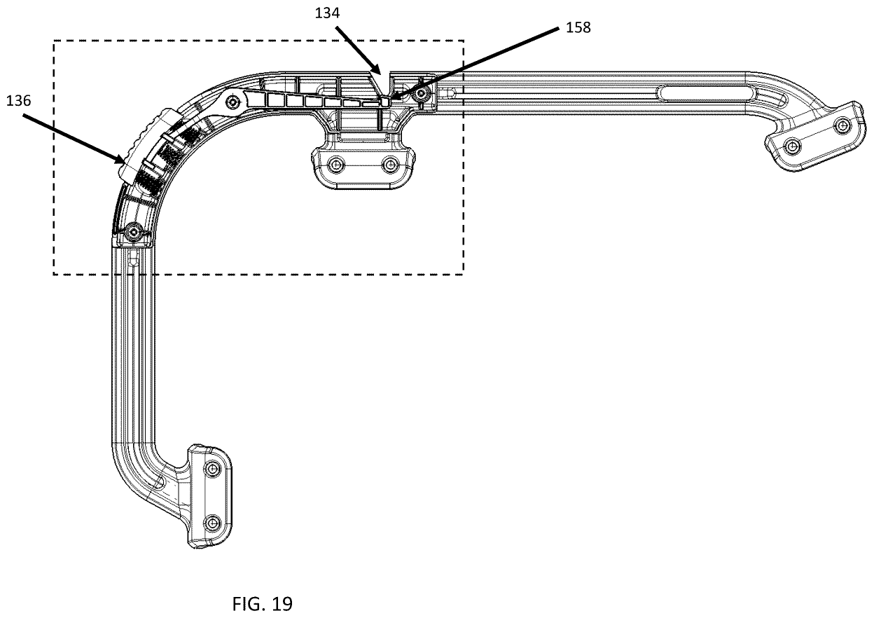

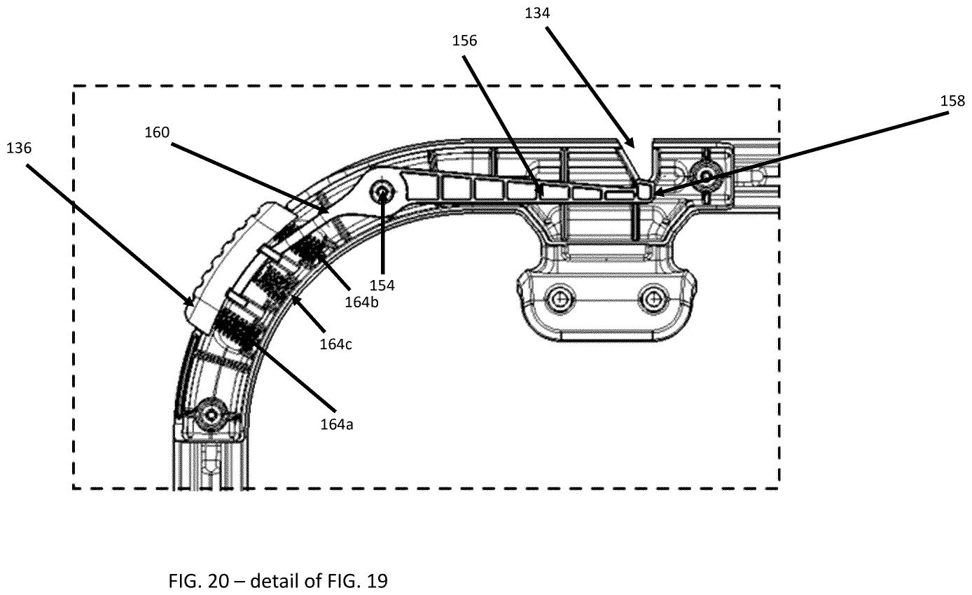

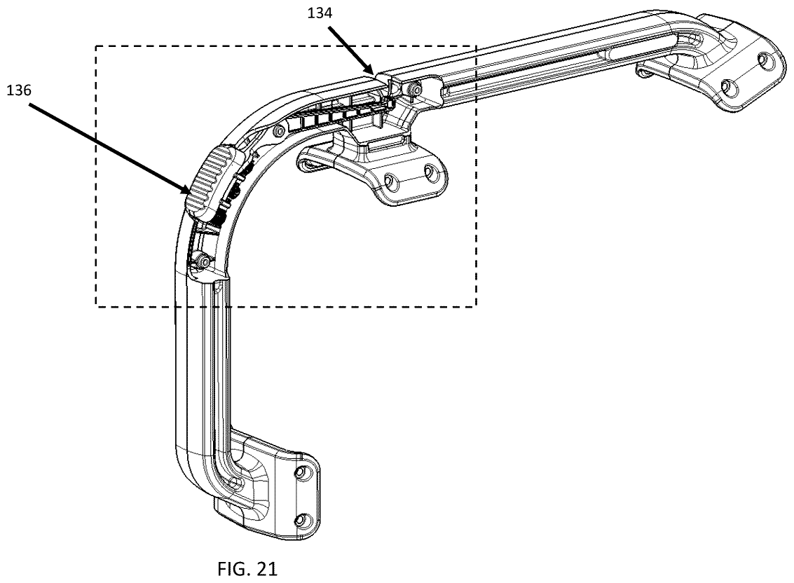

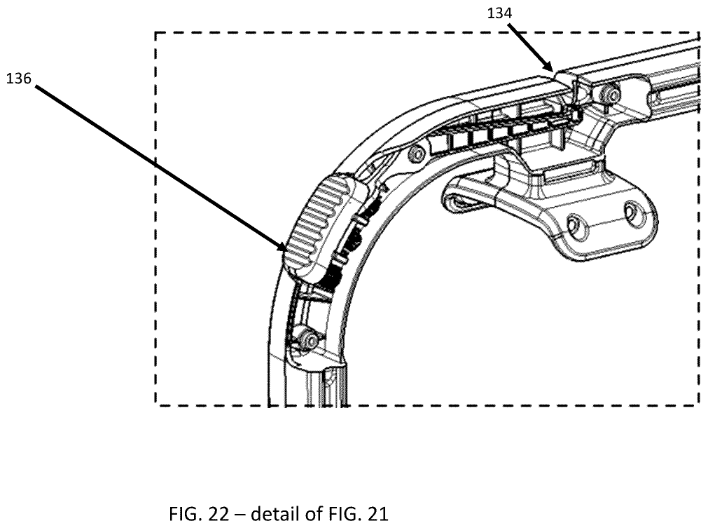

FIGS. 19-22 illustrate details regarding a handle 126 of the battery pack 110 when the battery pack 110 is in the default state.

The handle 126 may be made of a hard plastic forming a handle housing. The handle 126 may include at least one (in this example there are three) handle attachments 147. The handle attachments 147 provides an element for attaching the handle 126 to the housing. In the illustrated example embodiment, a first handle attachment 147a may attach to the left housing 122 and the right housing 124 at a rear side of the battery pack 110 and a second handle attachment 147b and a third attachment 147c may attach to the top housing 120. The handle attachments 147 may be coupled to the battery pack housing by one or more fasteners 149, such as screws.

The handle housing may define an internal cavity 148. As illustrated, a portion of the handle housing has been removed to expose the internal cavity 148 for illustration purposes.

As illustrated, within the internal cavity 148, the battery pack removal system may include class 1 lever 138. The lever 138 may include a fulcrum 152 that rotates about a pivot pin 154. The lever 138 may have a first arm (load arm) 156 extending from the fulcrum 152 and terminating in a latch engaging end 158. The lever 138 may have a second arm (effort arm) 160 extending from the fulcrum 152, in a direction generally opposed to the first arm 156 and terminating in a button engaging end 162. The removal system may also include a plurality of coil springs 164 between (1) the button engaging end 162 of the lever 138 and an internal wall of the internal cavity 148 and/or (2) the actuation button 136 and the internal wall of the internal cavity 148.

As illustrated in FIGS. 19-22, the removal system is in the default state. In other words, no force is being applied to the actuation button 136 and as such, the springs 164 are in their extended position applying a clockwise (in the orientation of FIGS. 19 and 20) force to the lever thereby forcing the latch engaging end 158 within the internal cavity 148 such that the latch engaging end 158 is not in the catch 134. As the force is applied to the actuation button 136 by the springs 164, the fulcrum 152 rotates clockwise (in the orientation of FIGS. 19 and 20) about the pivot pin 154.

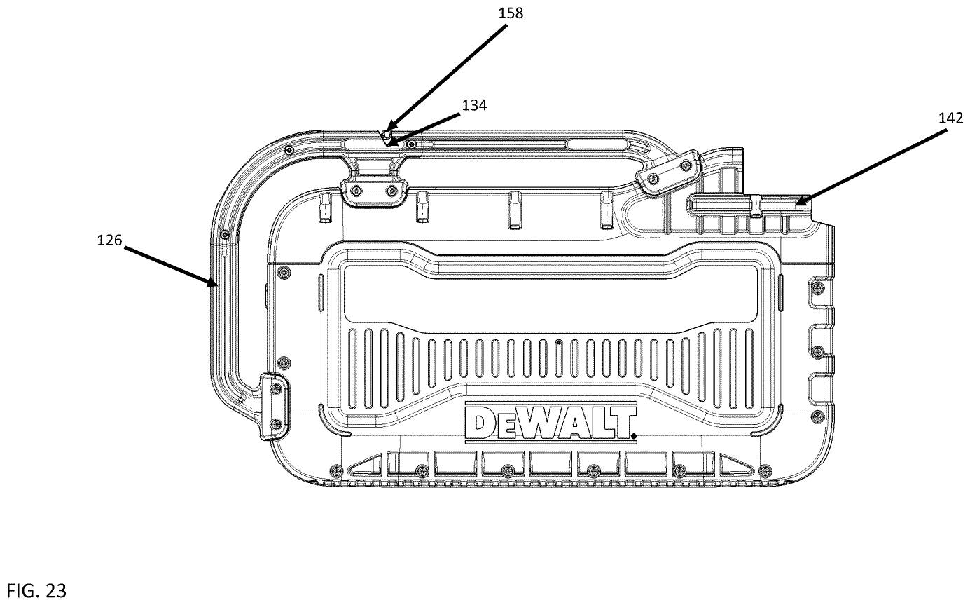

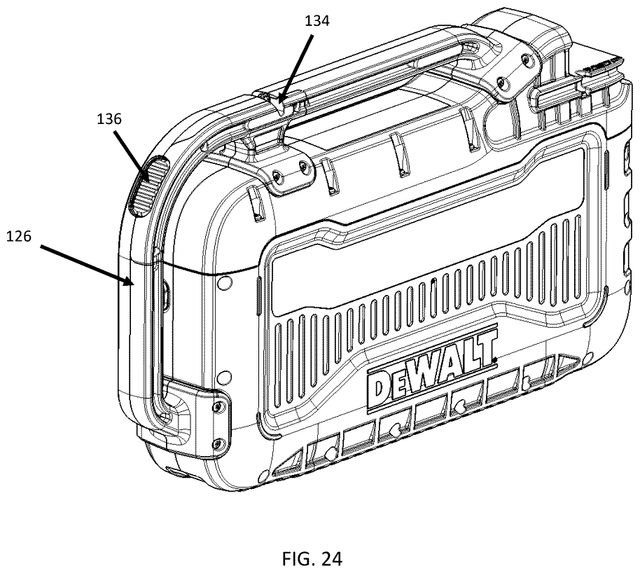

FIGS. 23 and 24 illustrate the example battery pack in a second state or configuration. This second state may be referred to as a removal state. In the removal state, the battery pack removal system is actuated.

When the battery pack 110 is in a lawn mower 100 a latch of the lawn mower 100 is positioned in the catch 134 to hold the battery pack 110 in place in the lawn mower 100. As illustrated, the actuation button 136 has moved into the handle 126 (for example, into the internal cavity 148 of the handle 126). Furthermore, the latch engaging end 158 of the first arm 156 has moved into the catch 134. When the actuation button 136 is depressed (a force is applied to the button 136) the latch engaging end 158 engages the latch and forces the latch out of the catch 134.

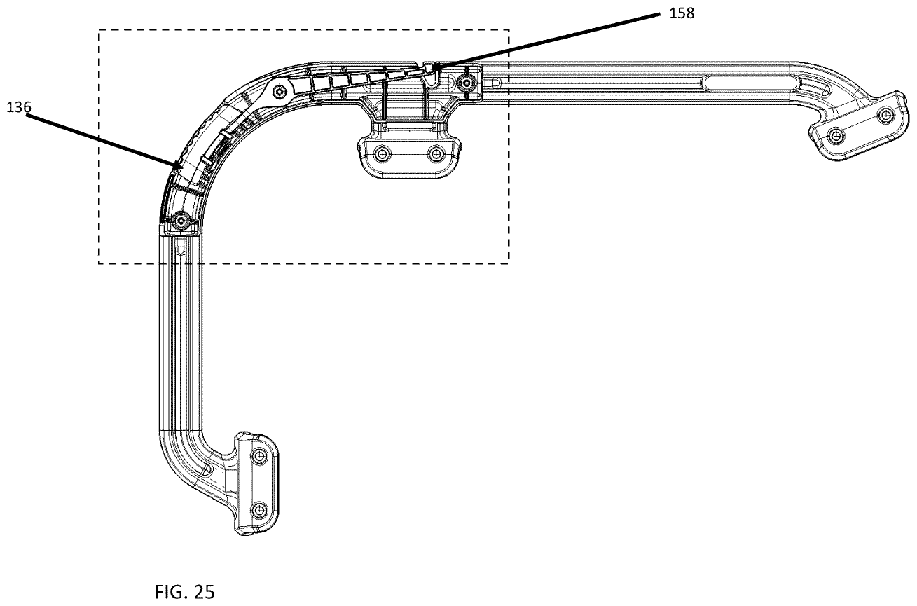

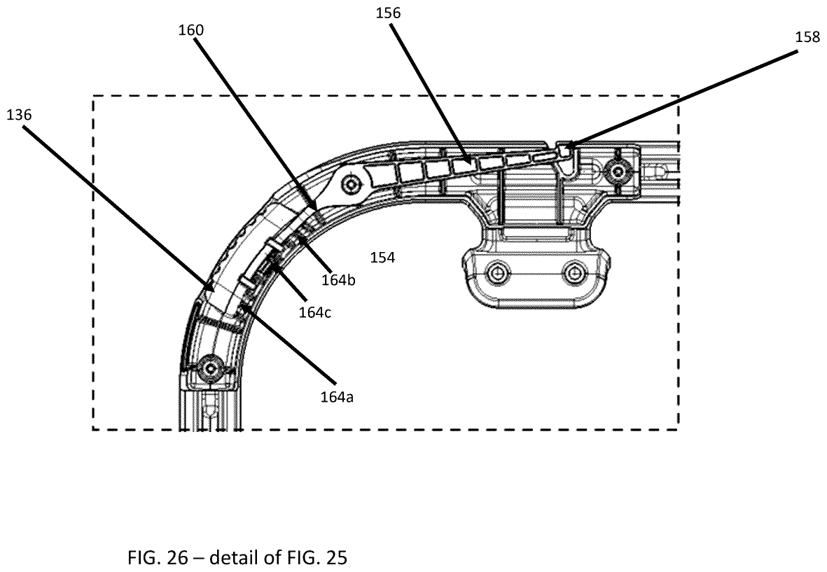

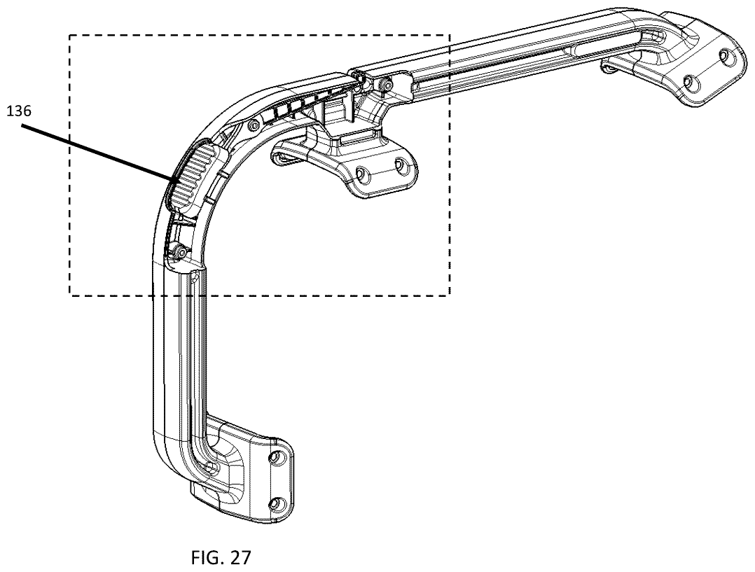

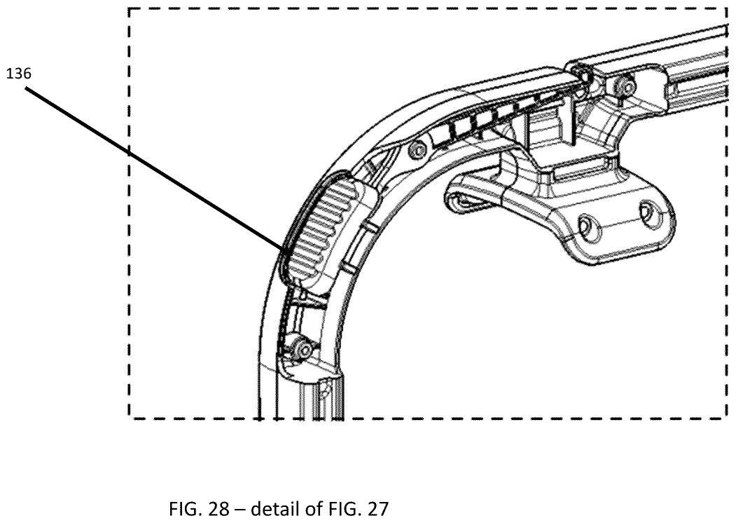

FIGS. 25-28 illustrate details regarding the handle 126 of the battery pack 110 when the battery pack 110 is in the removal state. In other words, a force is being applied to the actuation button 136 and as such, the springs 164 are in their compressed position. As such, a counterclockwise (in the orientation of FIGS. 19 and 20) force is applied to the lever thereby forcing the latch engaging end 158 into the catch 134. As the force is applied to the actuation button 136, the fulcrum 152 rotates counterclockwise (in the orientation of FIGS. 19 and 20) about the pivot pin 154.

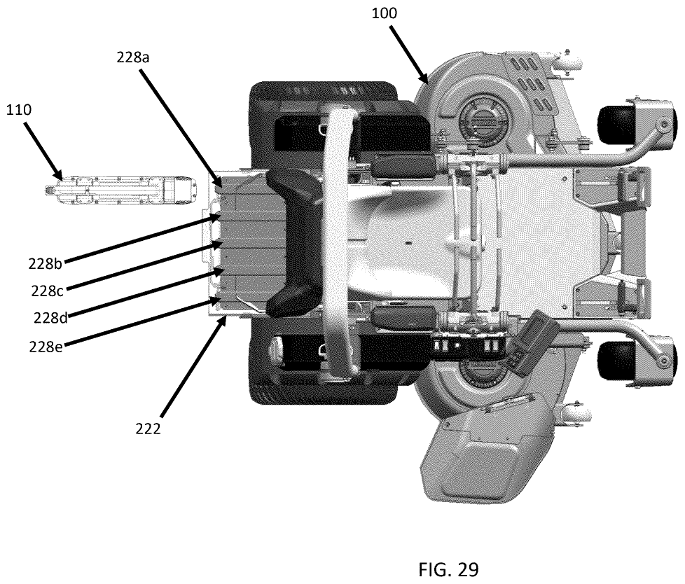

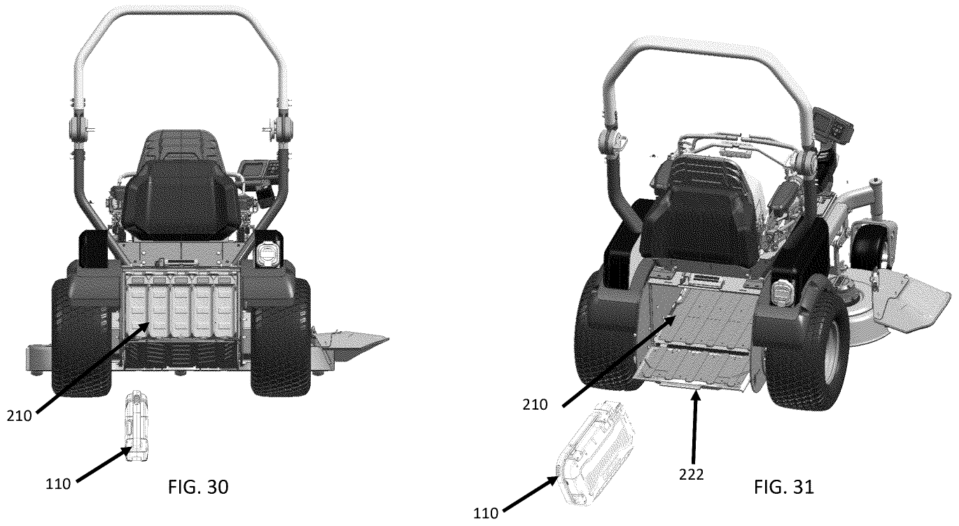

FIGS. 29-31 illustrate an example lawn mower and an example battery pack prior to inserting the battery pack into the lawn mower and the lawn mower receiving the battery pack. The example lawn mower may be lawn mower 100 described above and the example battery pack may be battery pack 110 described above. The lawn mower 100 may include a battery pack compartment 210. The battery pack compartment 210 may include a section/portion/space/place/volume/cavity to receive and hold the battery pack(s) 110.

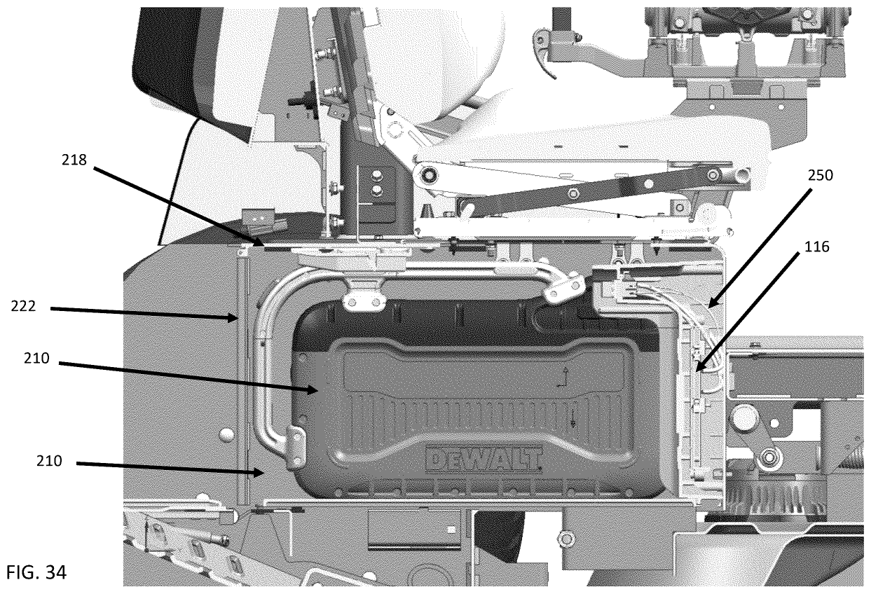

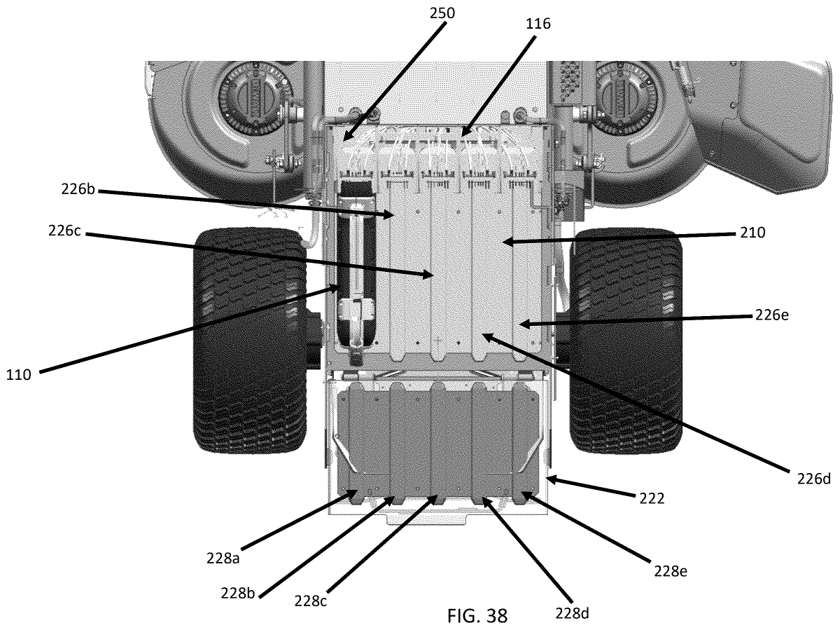

The lawn mower 100 may also include a section/portion/space/place/volume for electronics to monitor and control the battery pack(s) 110 (referred to simply as electronics space 250, infra). As illustrated in FIGS. 34 and 38, the electronics space 250 may be adjacent to the compartment 210.

There is a pack/tool interface—subsequently simply referred to as the “interface”—between the battery pack and the battery-powered tool. The interface includes a battery pack portion—sometimes referred to as a battery pack portion of the interface or a battery pack interface—and a battery-power tool portion—sometimes referred to as a tool portion of the interface or tool interface.

The battery pack compartment 210 serves as physical location to hold the battery pack(s) 110 and make a mechanical and electrical connections between the battery pack(s) 110 and the lawn mower 100. The battery pack compartment 210 may have a generally rectangular box shape. The compartment 210 may include a front wall 212, a left side wall 214, a right side wall 216, a top wall 218, a bottom wall 220 and a rear wall 222. The rear wall 222 also serves as a door to the compartment 210, as described in more detail below. The rear wall/door 222 may be connected to the compartment 210 by a hinge 224. The hinge 224 enables the rear wall/door 222 to fold down/open in a rearward direction such that the rear wall 222 may be generally in a same plane as the bottom wall 220.

The compartment 210 may have a plurality of positions, each position configured to receive an individual battery pack 110. The illustrated example battery pack compartment 210 includes five positions. Alternate battery pack configurations may include fewer or more positions.

Each position of the plurality of positions includes a discrete portion of the tool portion of the interface. In other words, in the illustrated example embodiment, the tool interface includes all five positions/receptacle 225a-e and the associated components/elements and each position/receptacle includes a discrete portion of the tool portion of the interface. In the example embodiment, there are five discrete portions of the tool portion of the interface.

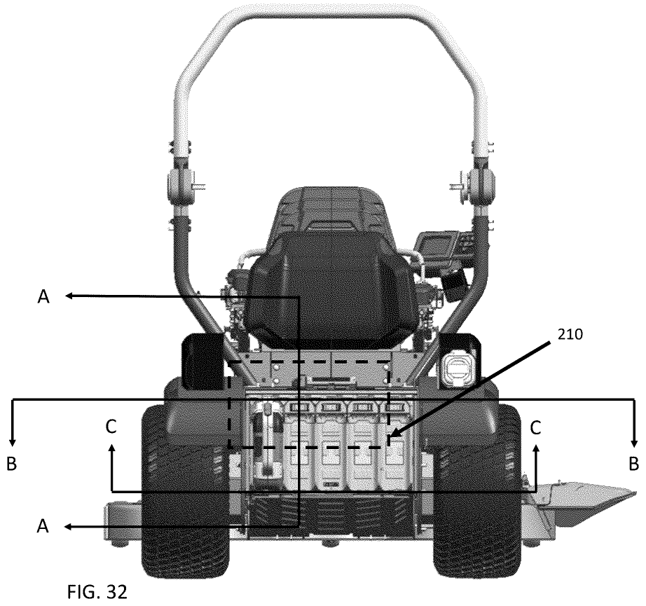

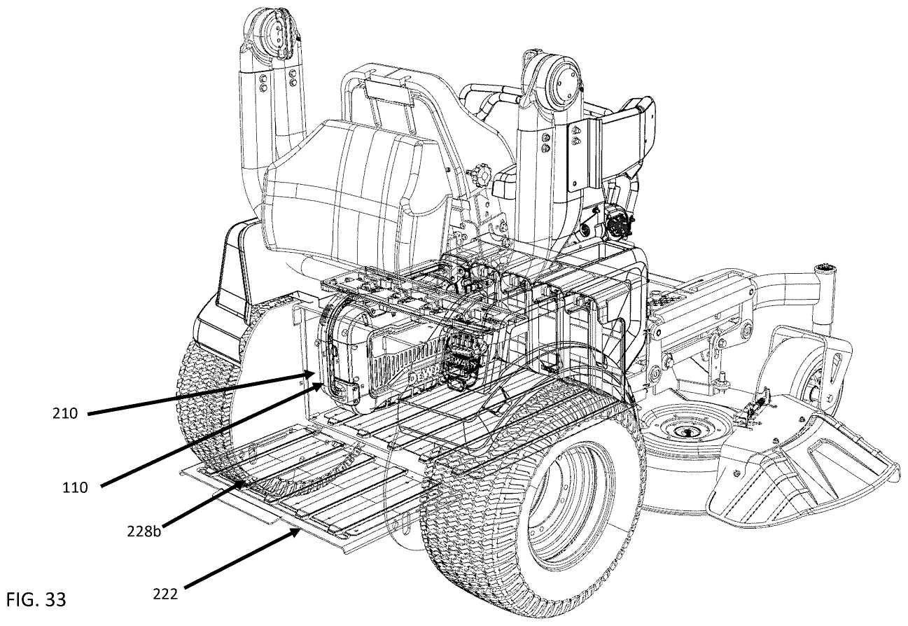

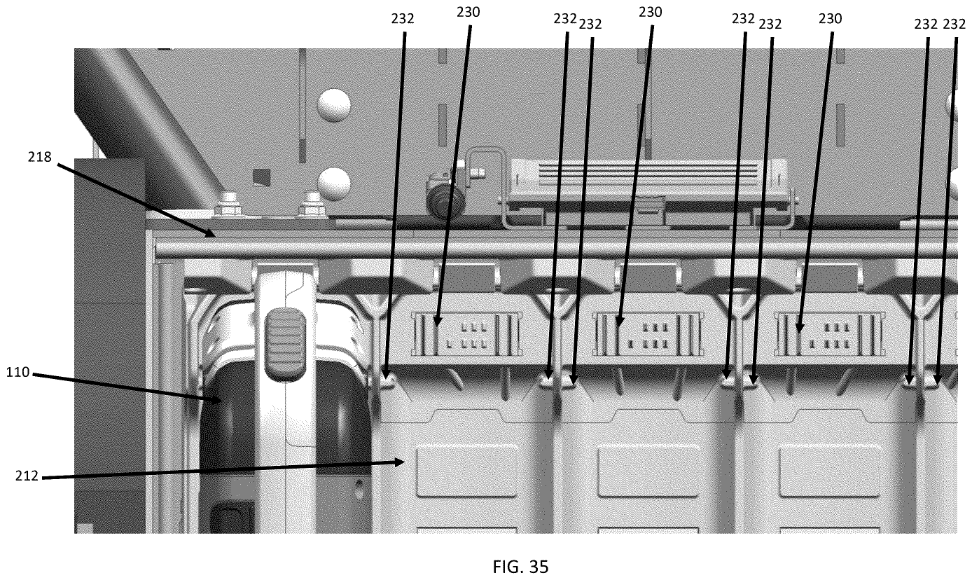

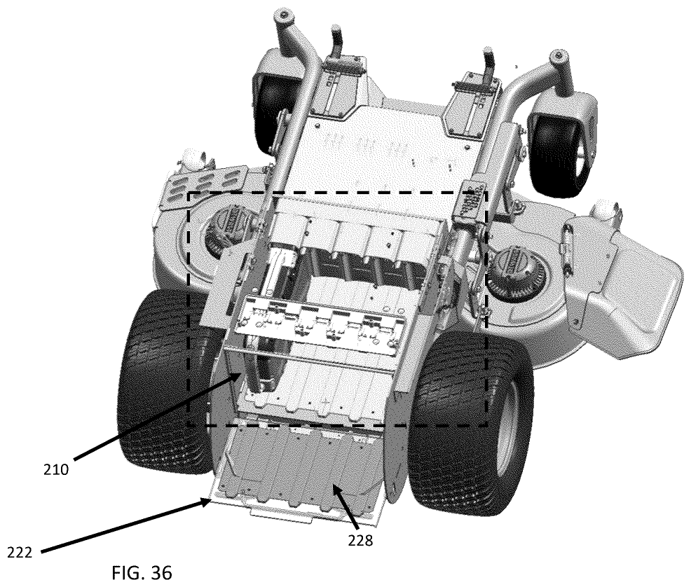

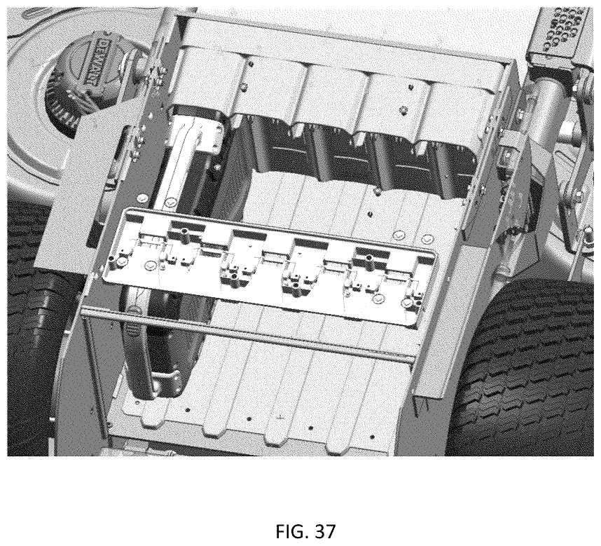

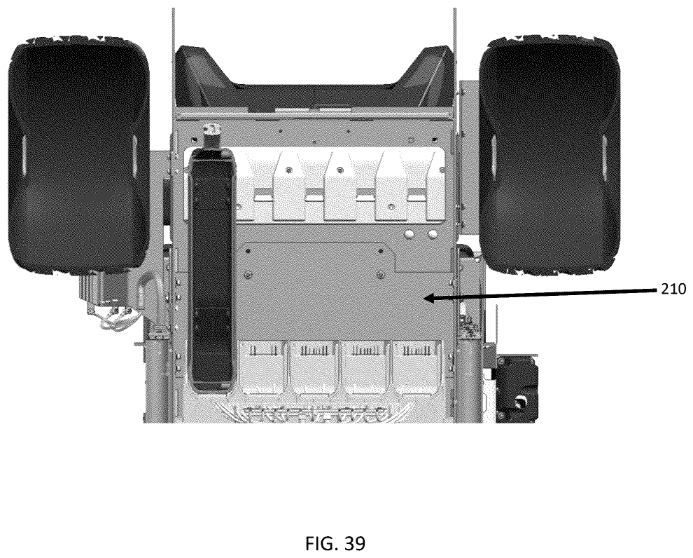

FIGS. 32-39 illustrate the first battery pack 110 inserted in the lawn mower 100 and the lawn mower 100 having received the battery pack 110. As illustrated in FIG. 32 thru 43, the battery pack 110 is positioned in Position 1 or a first position of the compartment 210.

Each position of the compartment 210 includes a receptacle for a battery pack 110. Each receptacle includes the tool portion of the interface. The tool portion of the interface may include, among other elements, a rail 226 on the bottom wall-sometimes referred to as an enclosure bottom rail. Specifically, each position includes a rail 226 (for a total of five rails 226a, 226b, 226c, 226d, 226e) extending along the bottom wall 220 in a direction in which the battery pack 110 is inserted into or removed from the compartment 210. The tool interface may also include a rail 228 on the rear wall. Specifically, each position includes a rail 228 (for a total of five rails 228a, 228b, 228c, 228d, 228e) extending along the rear wall 222 aligned with the rail 226 on the bottom wall 220 of the corresponding position. When the rear wall 222 is folded down to be in the same plane as the bottom wall 220, the rail 228 on the rear wall 222 and the rail 226 on the bottom wall 220 form an extended rail.

Each position may also include a set of tool terminals 230. The tool terminals 230 may be received in the battery pack terminal slots 144 and mate with a set of battery pack terminals. Each position may also include a pair of side rails 232. The side rails 232 are received in corresponding side grooves 142 of the battery pack 110. The side rails 232 and side grooves 142 serve to guide and align the battery pack 110 during insertion into the compartment 210 and to assist in holding the battery pack 110 in place during operation of the lawn mower 100.

The compartment 210 may also include a handle guidance/latching element 260. As described in more detail below, the handle guidance/latching element 260 guides the battery pack 110, particularly the battery pack handle 126 as the battery pack 110 is inserted into and removed from the compartment 210 and may assist to hold the battery pack 110 in place during operation of the lawn mower 100. The handle guidance/latching element 260 may also include a latch 262 that also may assist to hold the battery pack 110 in place during operation of the lawn mower 110.

As illustrated in FIGS. 34, 35, and 39, the handle guidance/latching element 260 may be attached to an interior surface of the top wall 218 of the compartment 210. The handle guidance/latching element 260 may include a same number of positions as the compartment 210.

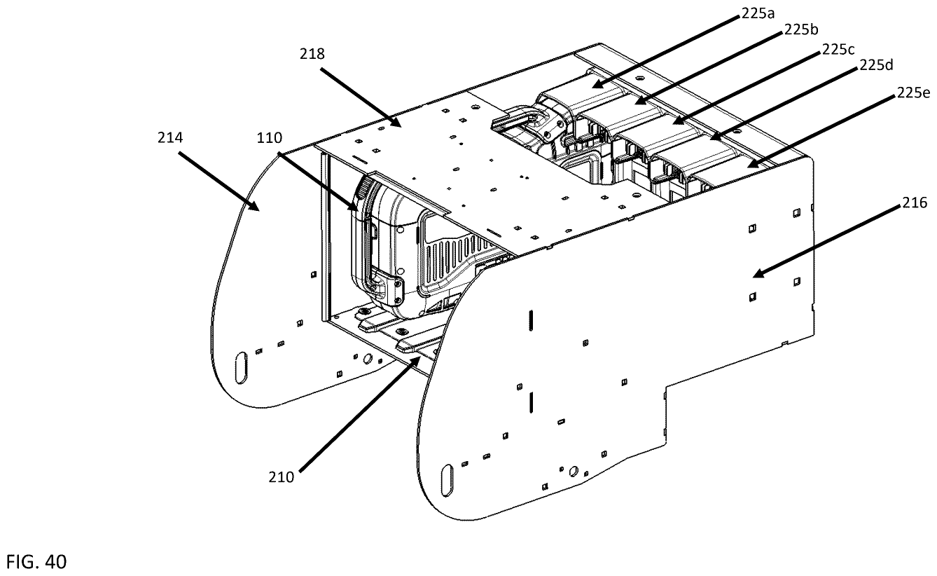

FIG. 40 illustrates a battery pack compartment 250 and a single received battery pack 110.

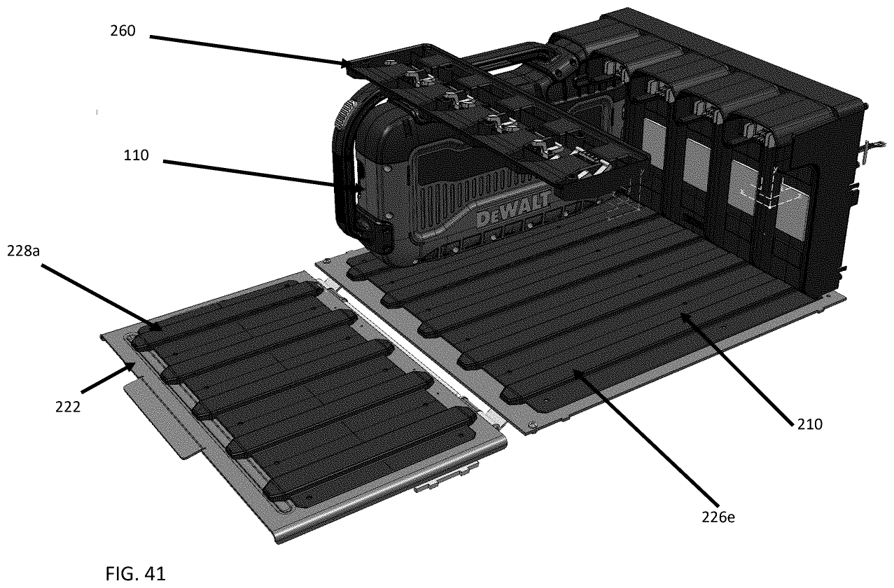

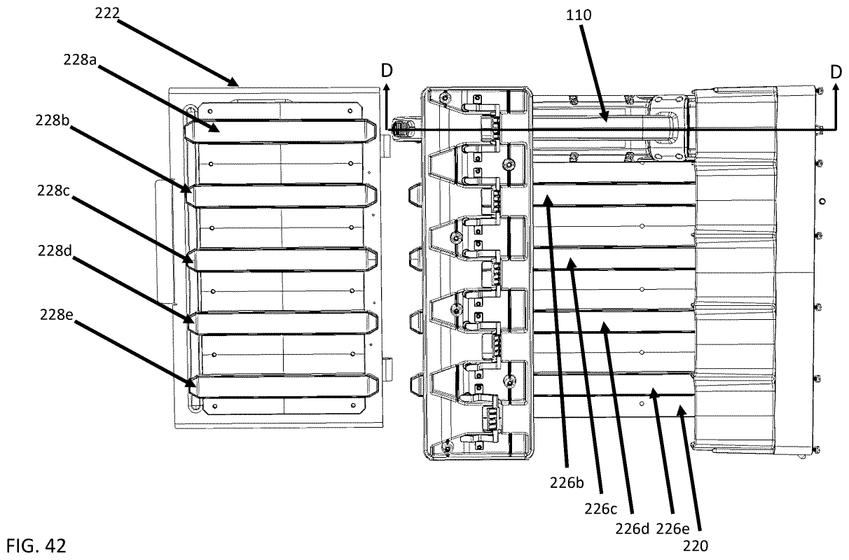

FIGS. 41 and 42 illustrate the battery pack compartment 250 with the side walls 214, 216 and the top wall 218 removed.

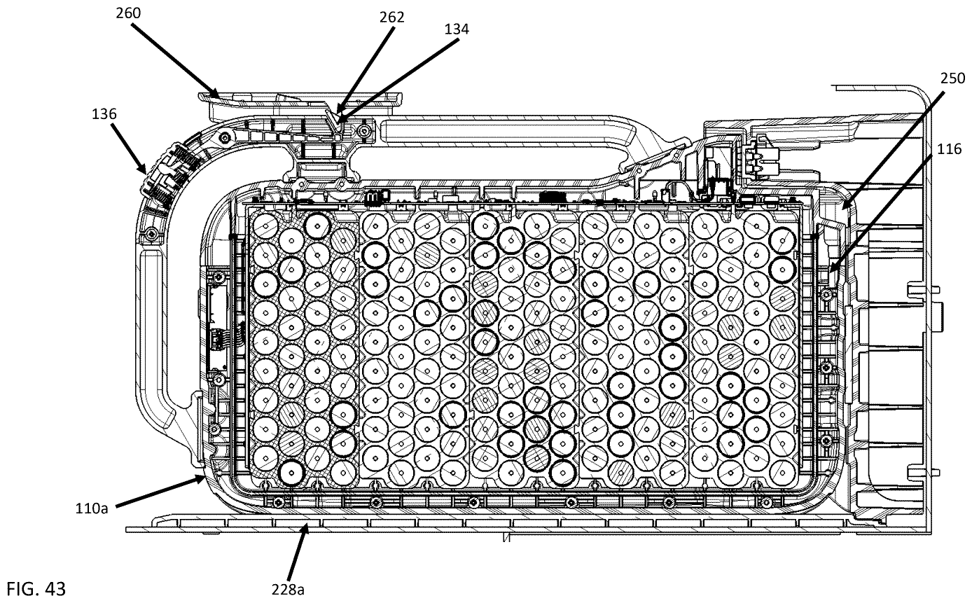

FIG. 43 illustrates a section view of the battery pack 110 and battery pack compartment 250 along section lines D-D of FIG. 42. The battery pack 110 and the lawn mower latching mechanism are both in their default states. The latch 262 is received in the catch 134. As such, the battery pack 110 is fixed in the battery pack compartment 250. In this configuration, the battery pack 110 is mechanically and electrically mated to the lawn mower 100.

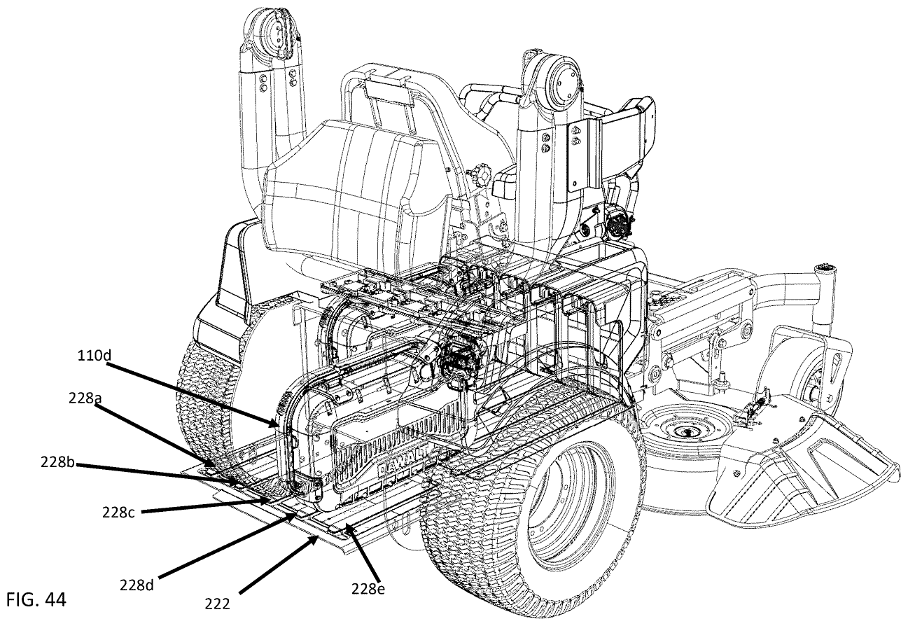

FIG. 44 illustrates a second battery pack 110d being inserted into the compartment 210 at position 4.

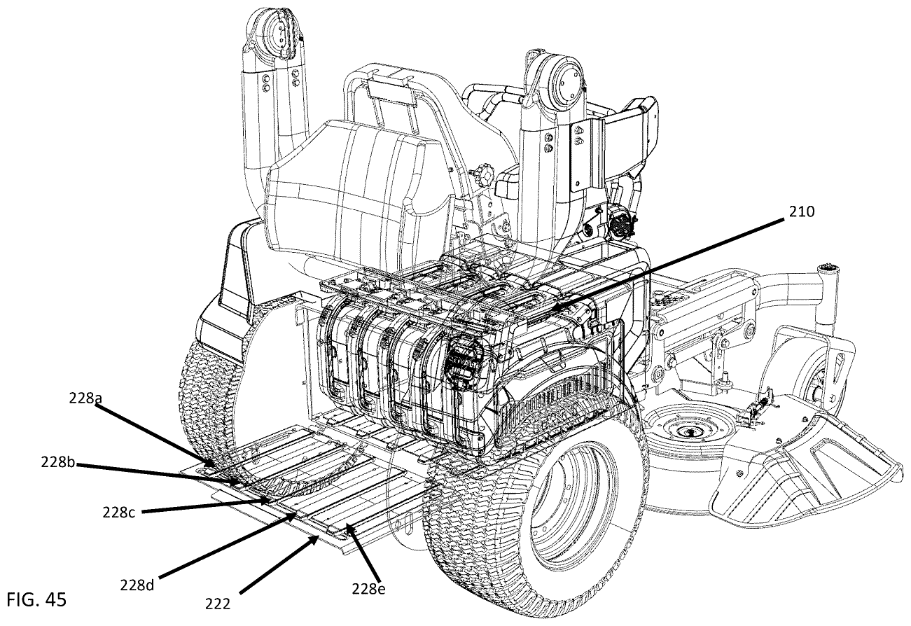

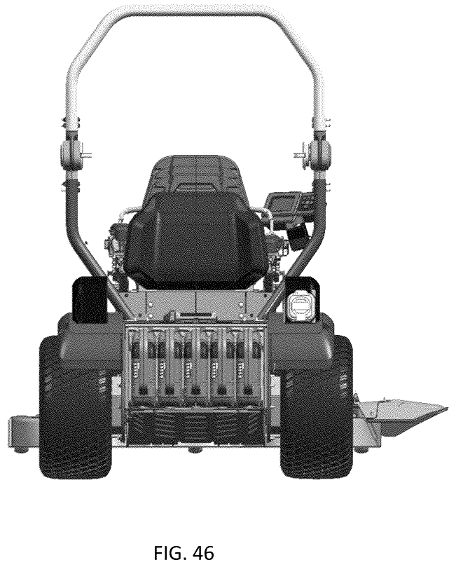

FIGS. 45 and 46 illustrate five example battery packs 110a-e received in the battery pack compartment 210 and coupled/mated to the lawn mower 100.

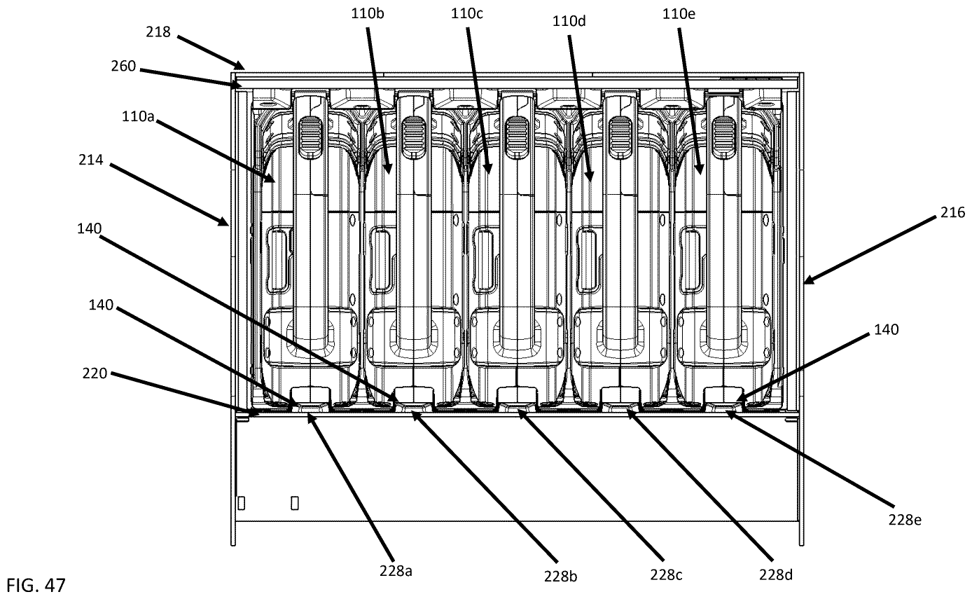

FIG. 47 illustrates a detail rendering of the five example battery packs 110 received in the battery pack compartment 250. As illustrated, each of the enclosure bottom rails 228a-228e is received in a corresponding slot 140 of the corresponding battery pack 110 received in the compartment 210 at each position 225. In other words, the rail 228a is received in the slot 140 of the battery pack 110a in position 1, the rail 228b is received in the slot 140 of the battery pack 110b in position 2, the rail 228c is received in the slot 140 of the battery pack 110c in position 3, the rail 228d is received in the slot 140 of the battery pack 110d in position 4 and rail 228e is received in the slot 140 of battery pack 110e in position 5.

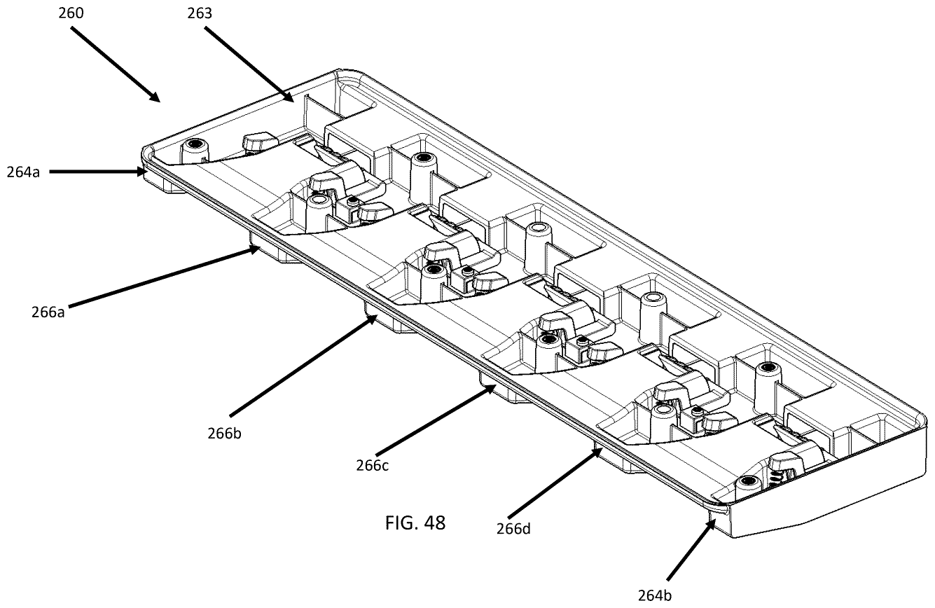

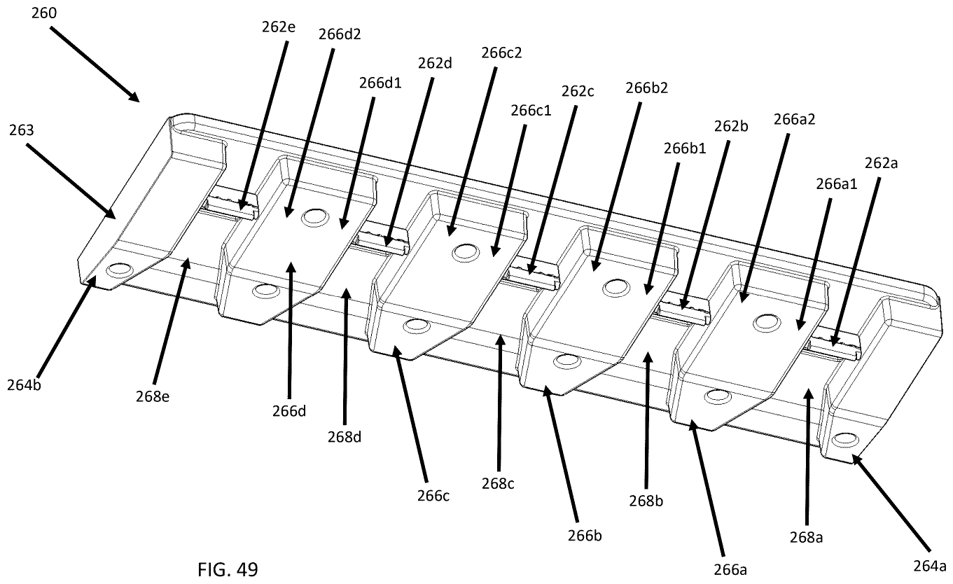

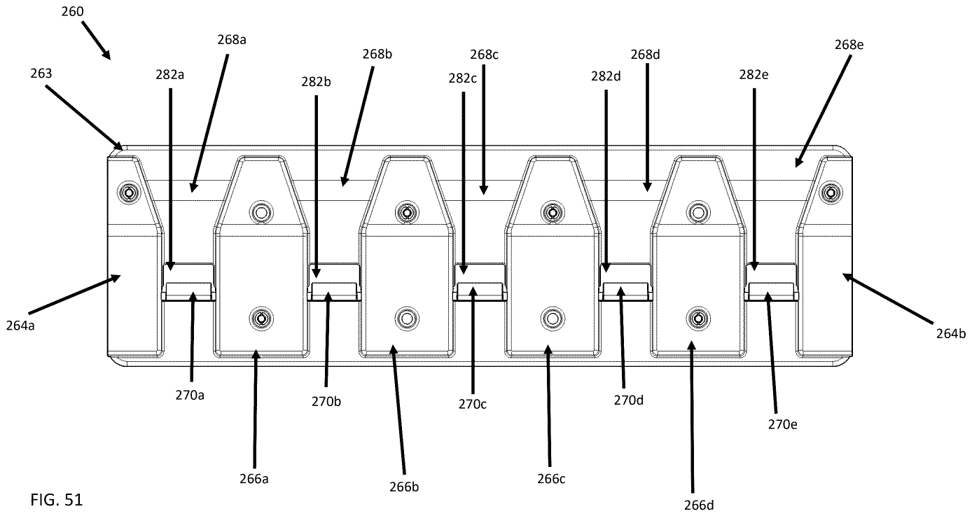

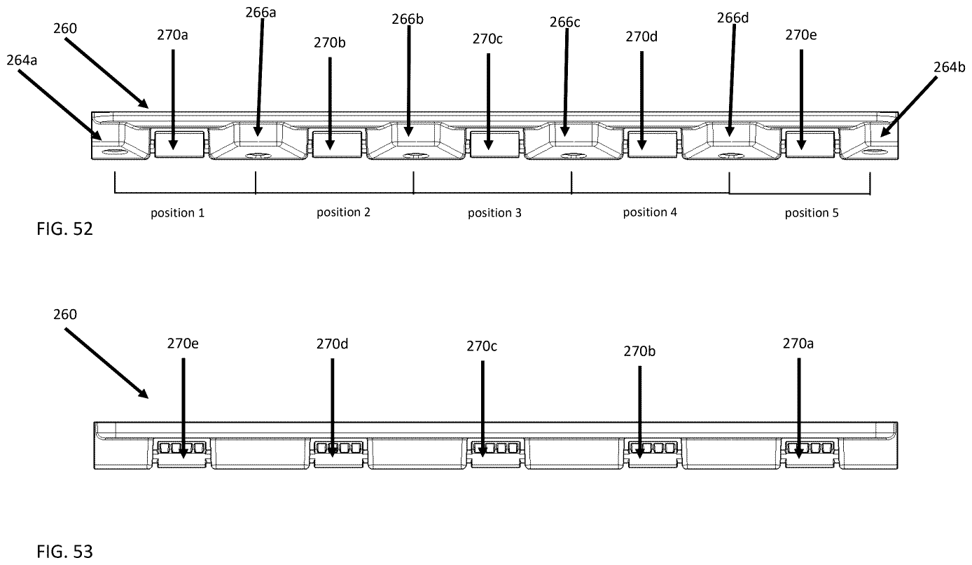

FIGS. 48-55 illustrate the battery pack handle guidance/latching element (sometimes referred to as a guidance/latching mechanism) 260 that is a part of (an element of) the tool interface of the lawn mower 100. The guidance/latching mechanism 260 is illustrated in these figures in a first state or configuration. This first state may be referred to as a default state. In the default state, all of the latches 262 of the latching mechanism are in a latching position/coupling position/state/configuration. The handle guidance/latching element 260 includes a housing 263.

The guidance/latching mechanism 260 may include a plurality of rails sometimes referred to as top rails or enclosure top rails 264. The plurality of rails may include half rails 264 and full rails 266. Each full rail 26 includes two half rail portions 264b1 and 264b2. Furthermore, a plurality of grooves-sometimes referred to as top grooves or enclosure grooves 268 are formed by adjacent top rails 264. Specifically, the half rail 264a and the half rail portion 266a1 of rail 266a define/form a first top groove 268a, the half rail portion 266a2 of rail 266a and the half rail portion 266b1 of rail 266b define/form a second top groove 268b, the half rail portion 266b2 of rail 266b and the half rail portion 266c1 of rail 266c define/form a third top groove 268c, the half rail portion 266c2 of rail 266c and the half rail portion 266d1 of rail 266d define/form a fourth top groove 268d, and the half rail portion 266d2 of rail 266d and the half rail 264b define/form a fifth top groove 268e.

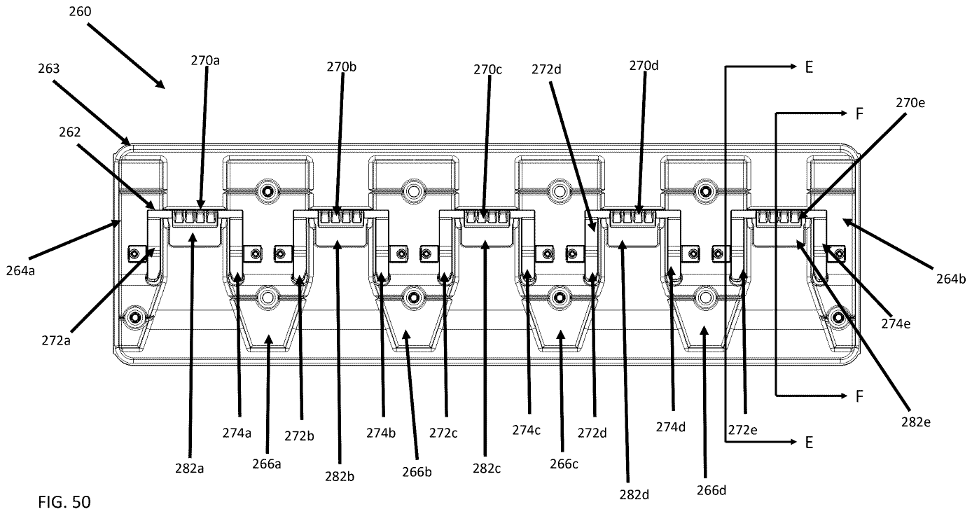

As illustrated in FIG. 50, each latch 262a-e of the plurality of latches includes a crossbar member 270, a first leg member 272 attached to and extending generally perpendicularly to a first end of the crossbar member 270 and a second leg member 274 attached to and extending generally perpendicularly to a second end of the crossbar member 270. The first leg member 272 and the second leg member 274 are generally parallel to each other.

Each latch 262 is rotatably coupled to the handle guidance/latching element housing 263 by a pair of pivot arms 276. Each pivot arm 276 of the pair of pivot arms extends from an associated leg member 272 or 274. As such, there is a pivot arm 276 on each side of a groove 268. The pivot arms 276—and therefore the latch 262—is held in place by a corresponding arm holddown 278 that allows the latch 262 to rotate about an axis of the pivot arm 274 that is generally perpendicular to the leg member 272, 274.

A coil spring 280 is located between the handle guidance/latching element housing 263 and a second end of each of the leg members 272, 274—the second of the leg members 272, 274 being opposed to an end of the leg members 272, 274 attached to the cross member 270.

The handle guidance/latching element housing 263 includes an opening 282 associated with each groove 268 that provides passage from an inner surface of the handle guidance/latching element 260 (a side that faces the battery pack compartment 250) and an outer surface of the handle guidance/latching element 260 (a side opposed to the inner surface).

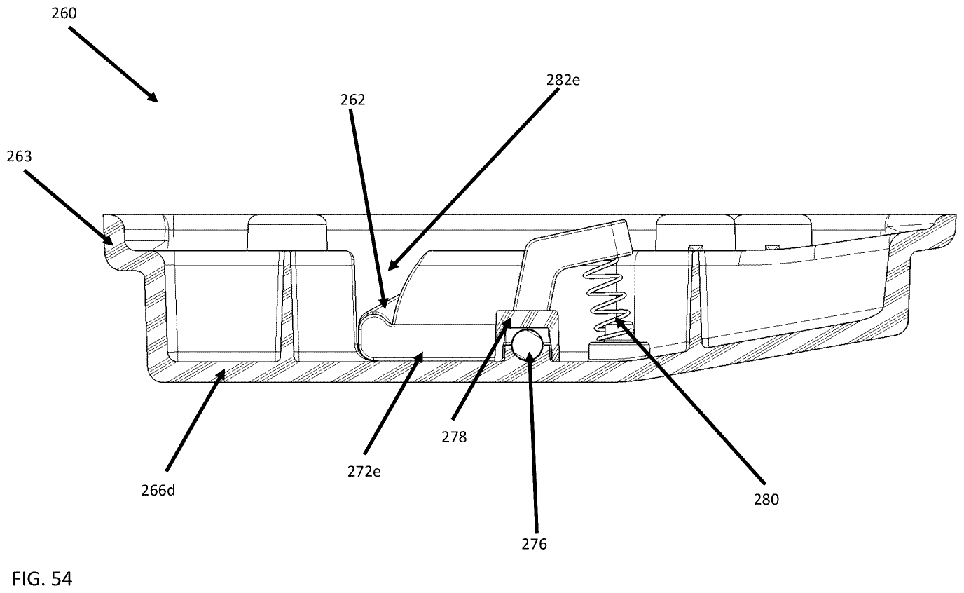

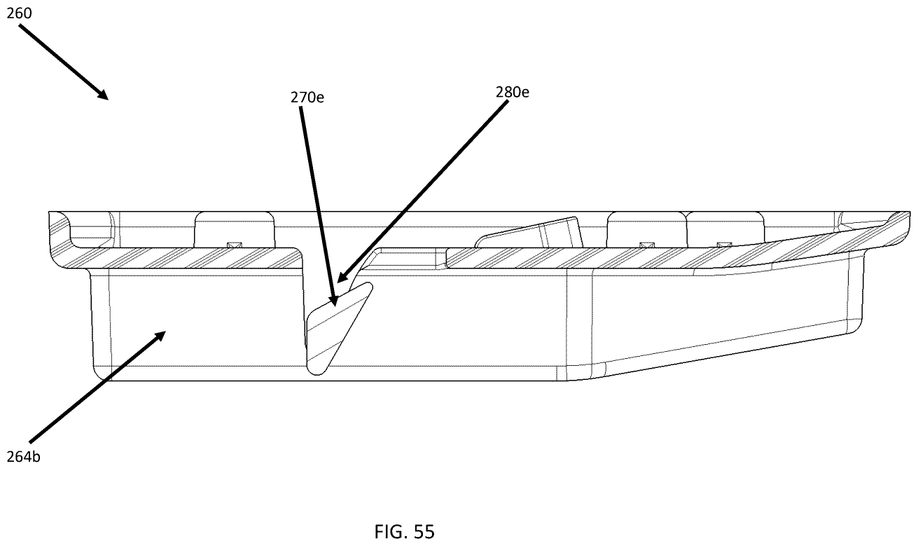

As illustrated in FIGS. 54 and 55, the spring 280 forces the latch 262 into the corresponding opening 282. This is considered the default/latching state.

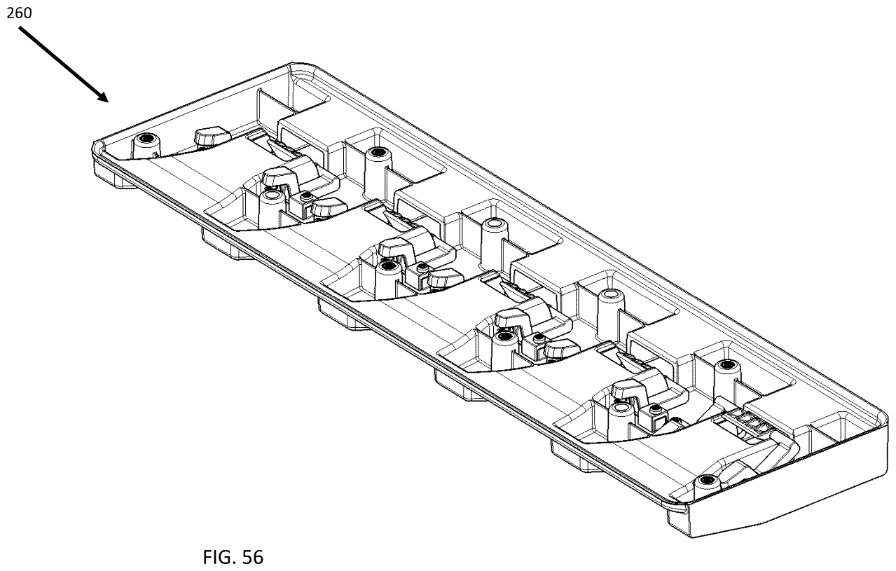

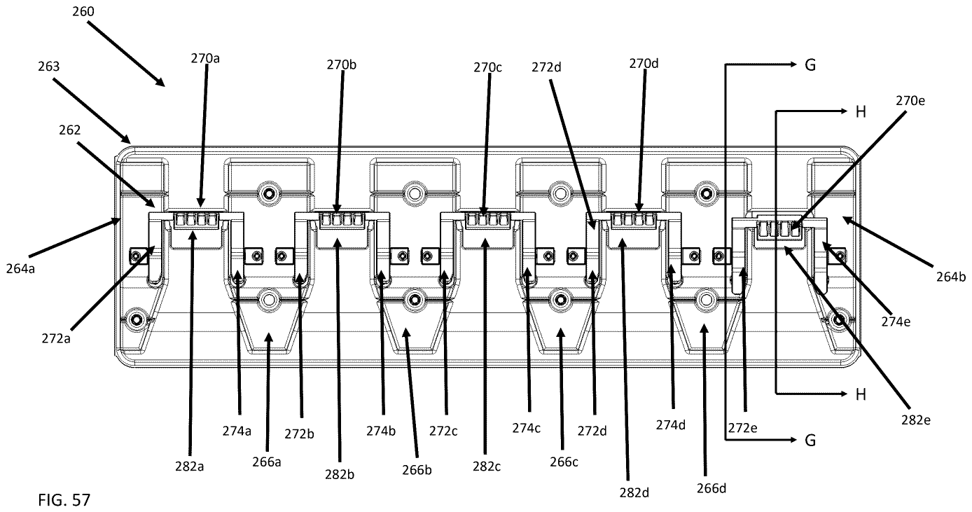

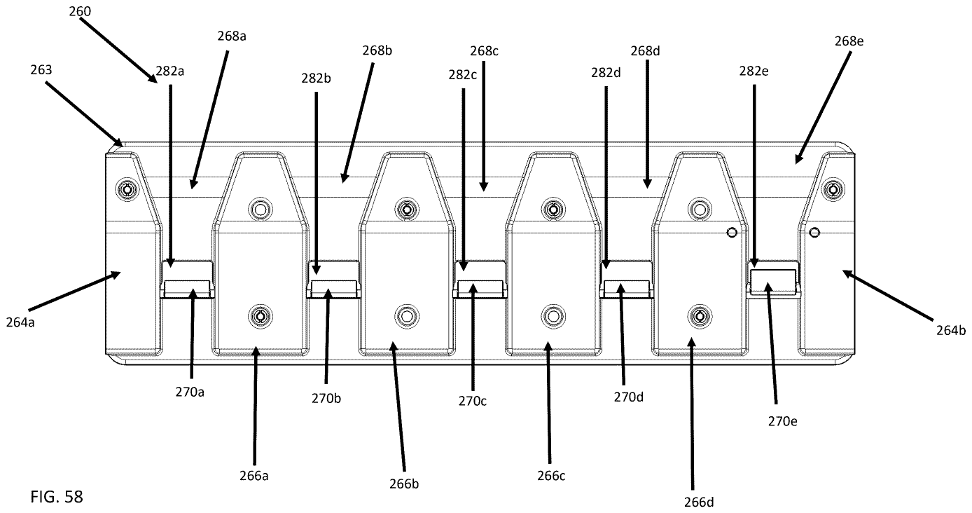

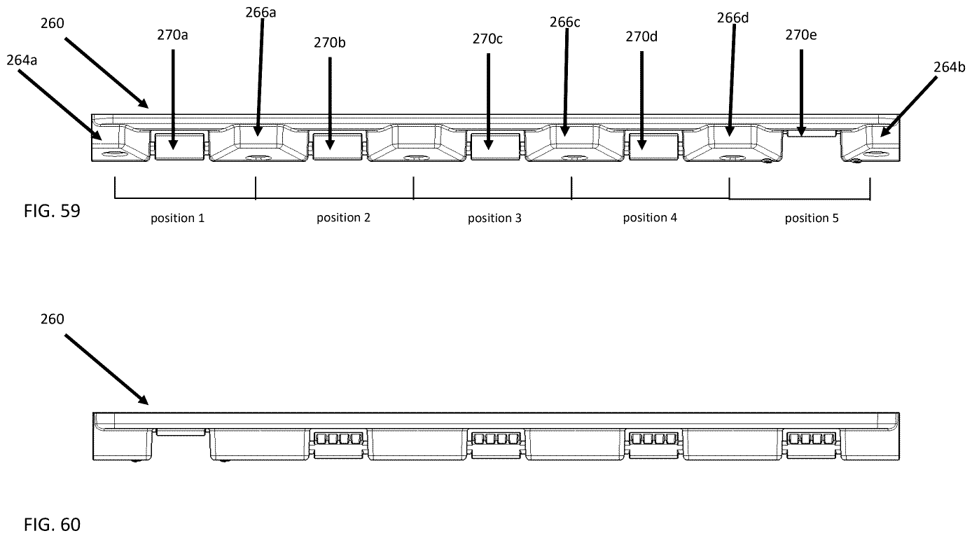

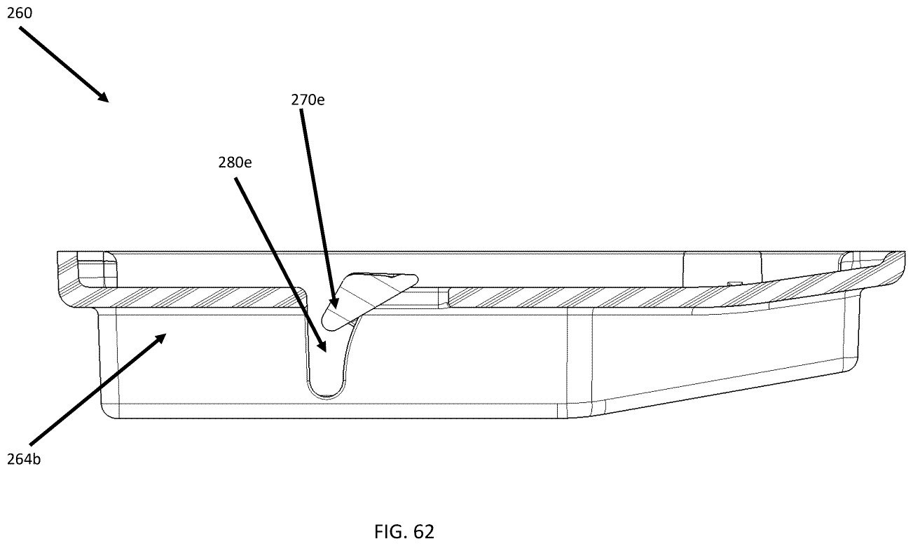

FIGS. 56-62 illustrate the battery pack handle guidance/latching element 260 in a second state or configuration. This second state may be referred to as a removal state. In the removal state, at least one of the latches 262 of the latching mechanism is in an unlatching/uncoupling position/state/configuration. The example guidance/latching element 260 includes five latches 262, one associated with each battery pack receptable. Each of the latches 262 may be individually/independently placed in the unlatching/uncoupling position.

As such, when any of the latches 262 is in the unlatching position, the guidance/latching element 260 may be referred to as in the removal state.

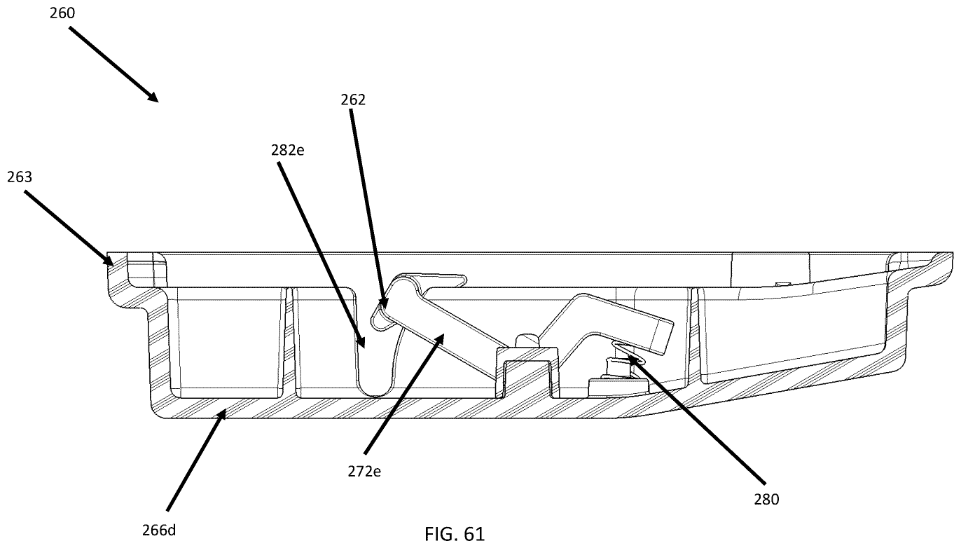

As illustrated, for example, in FIG. 61, the latch 262 is rotatable about the pivot arms 276 in a clockwise direction (in the context of FIG. 61). The latch 262 may be rotated when acted upon the lever 138 of the battery pack 110, as discussed in more detail below.

When the latch 262 rotates from the latching position to the unlatching position the cross member 276 is substantially moved out of the opening 282 in the handle guidance/latching element housing 263.

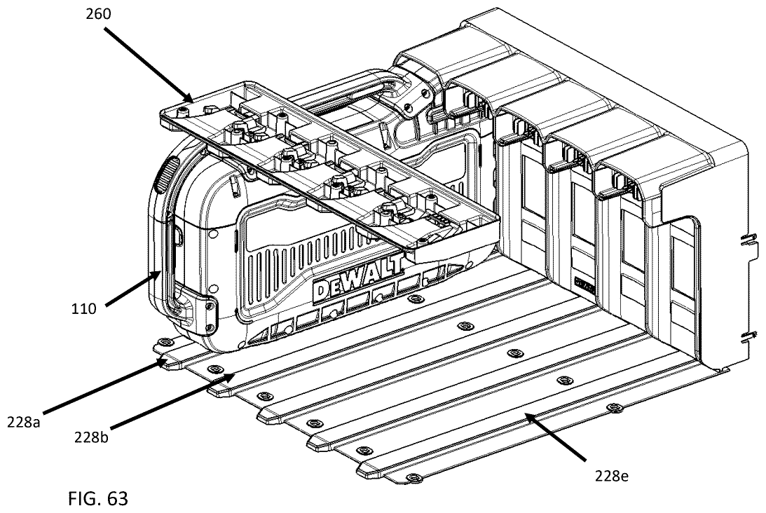

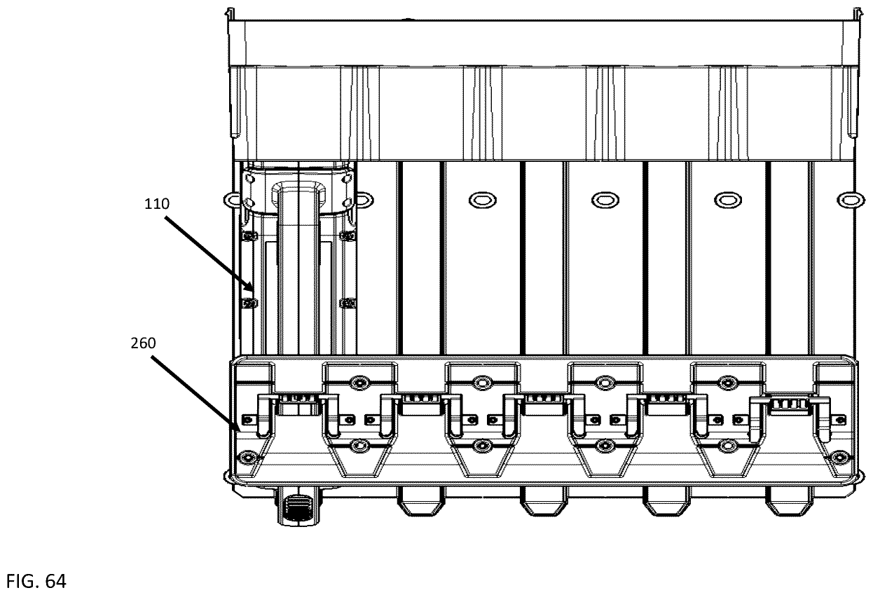

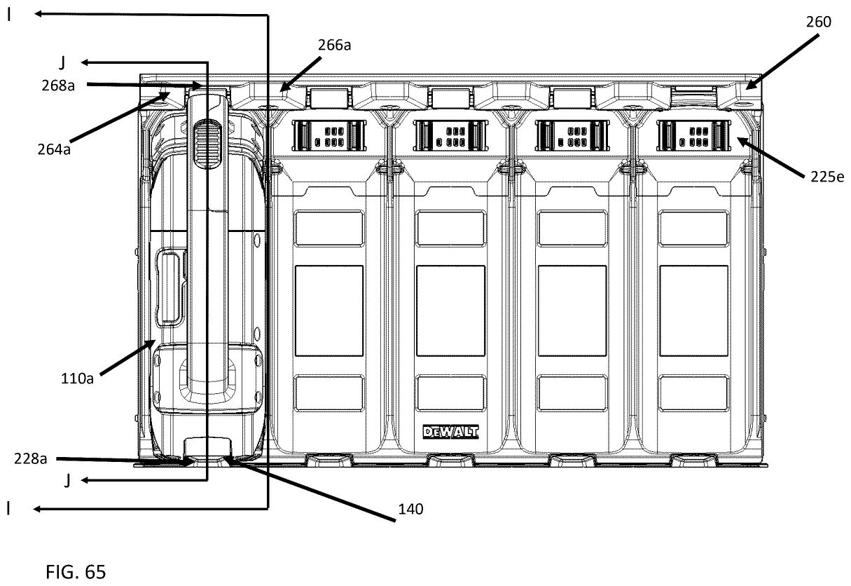

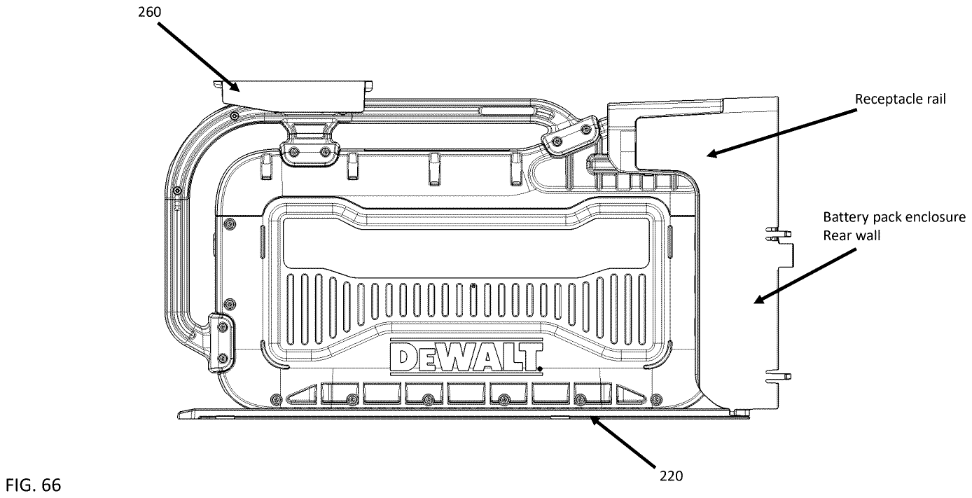

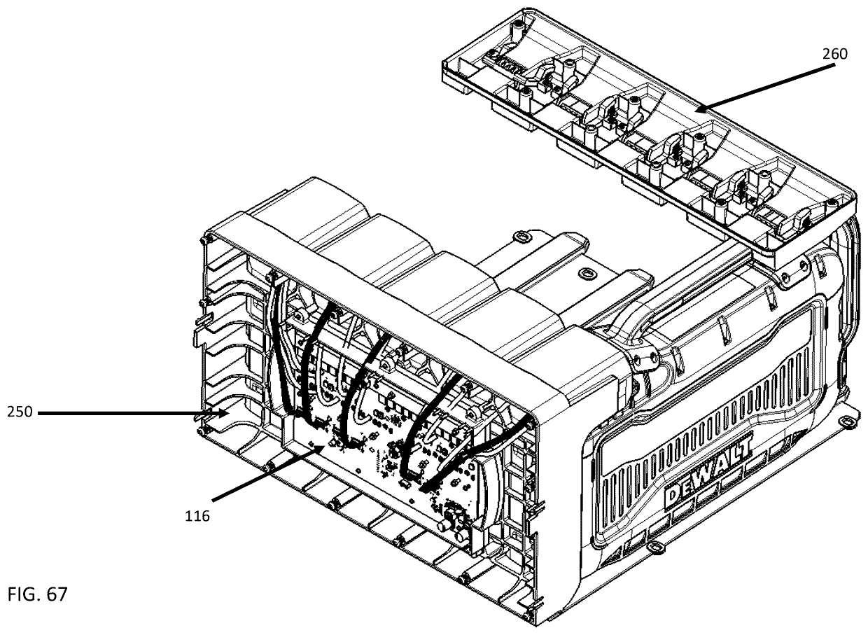

FIGS. 63-68 illustrate the example battery pack 110 mated/connected/coupled to a corresponding battery pack receptacle 225 and the handle guidance/latching element 260. The battery pack receptacle 225 is also a part of (an element of) the battery pack interface of the lawn mower. The battery pack interface of the lawn mower 100 will include a battery pack receptacle 225 for each battery pack 110 to be received by the lawn mower 100.

As illustrated in FIGS. 63-68 , when the battery pack 110 is fully seated in (mated to) the lawn mower 100, a bottom rail 228 of the compartment 250 is received in the groove 140 of the battery pack 110 and the handle 126 of the battery pack 110 is received in the top groove 268 of the compartment 250 such that the latch 262 of the handle guidance/latching element 260 is received in the catch 134 of the battery pack 110.

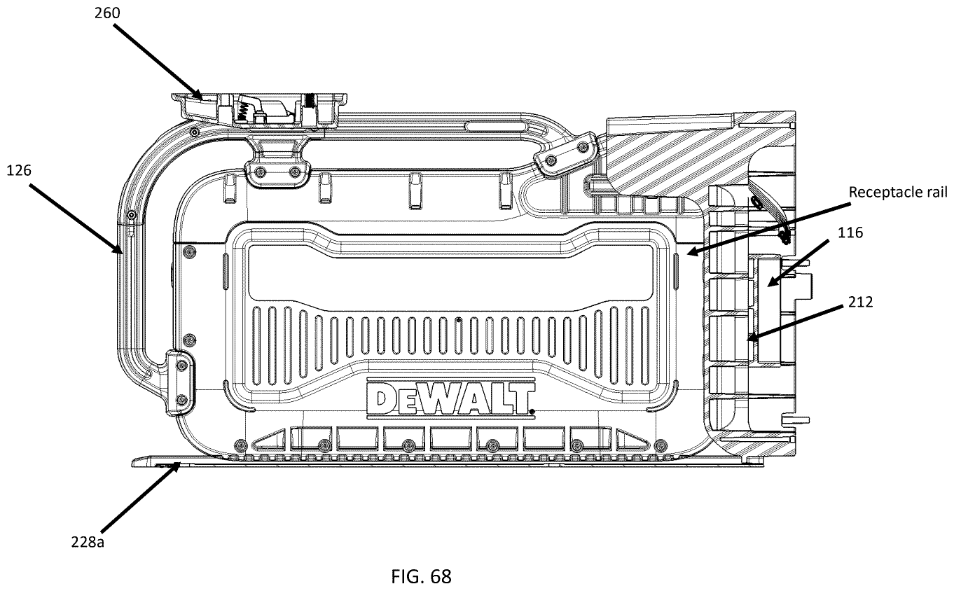

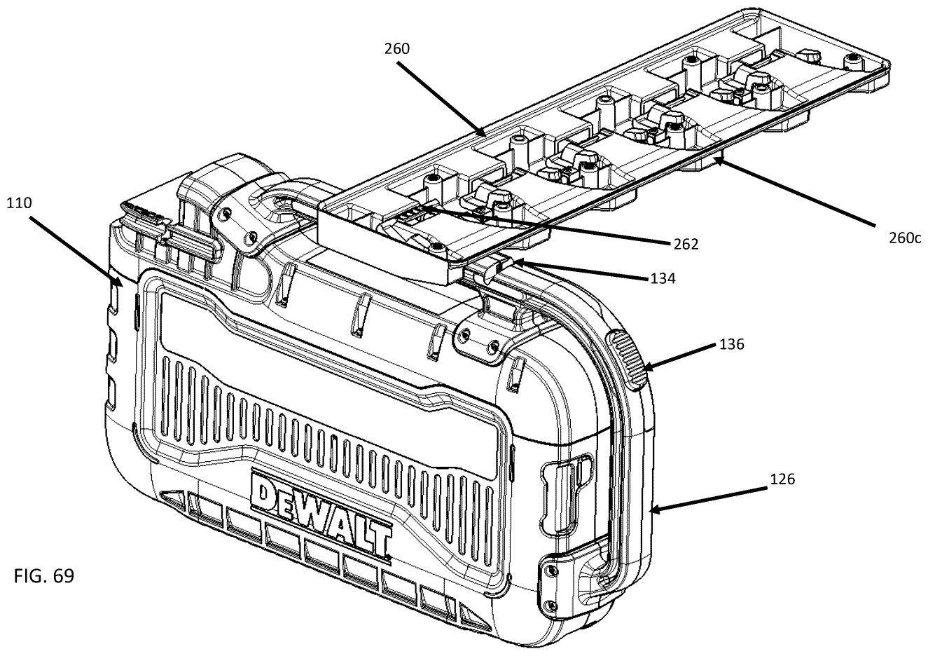

FIG. 69 illustrates an example battery pack 110 prior to insertion (moving in an insertion direction-forward) or after removal (moving in a removal direction-rearward). In this position, the battery pack 110 is rearward of the handle guidance/latching element 260. In this configuration, the latch 262 associated with the illustrated battery pack 110 (the battery pack being inserted or removed) is in the unlatching position and the handle guidance/latching element 260 is in the removal state. In this configuration, the latch 262 associated with the battery pack 110 being inserted or removed is being held in (forced into) the removal state by the battery pack handle 1126.

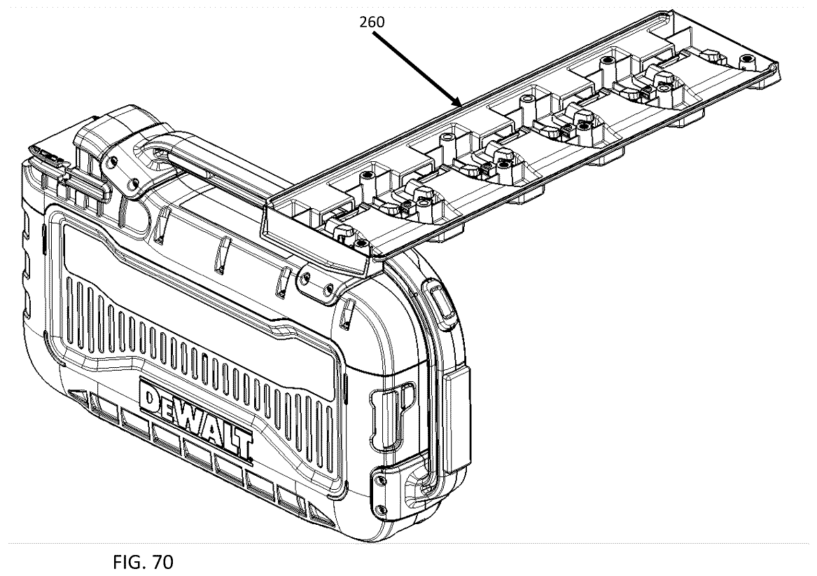

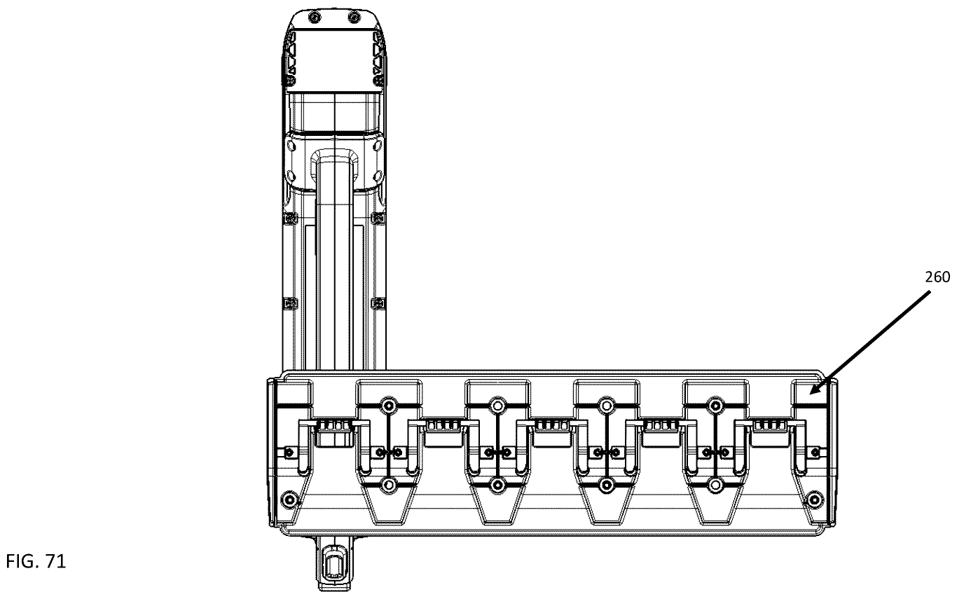

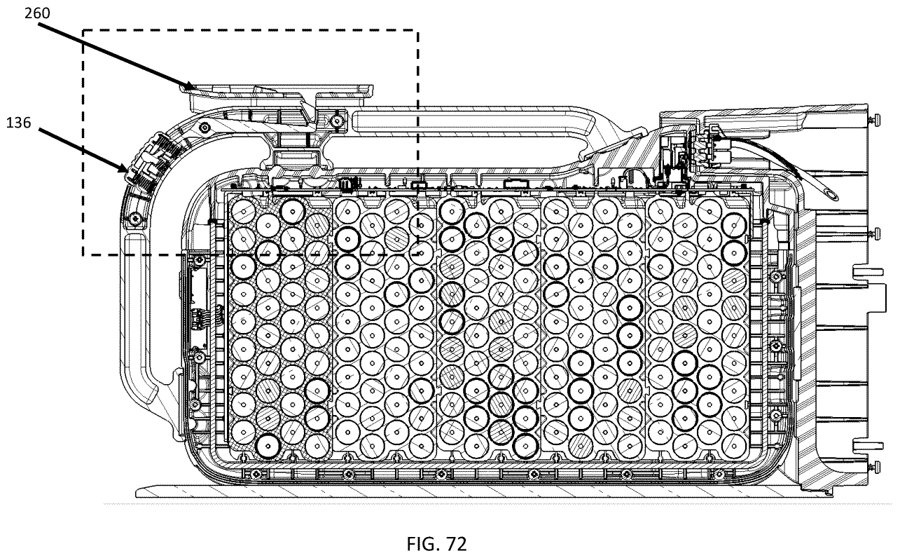

FIGS. 70-73 illustrate the example battery pack 110 in a fully coupled/mated/seated position. Furthermore, the latch 262 associated with the example battery pack 110 is in the latched position and the handle guidance/latching element 260 is in the default state. In this configuration, the latch 262 associated with the battery pack 110 coupled to the lawn mower 100 is received in the catch 134 in the battery pack handle 126. As such, the battery pack 110 is mechanically fixed/held in the battery pack compartment 210 and mechanically and electrically fixedly coupled to the associated battery pack receptacle 225.

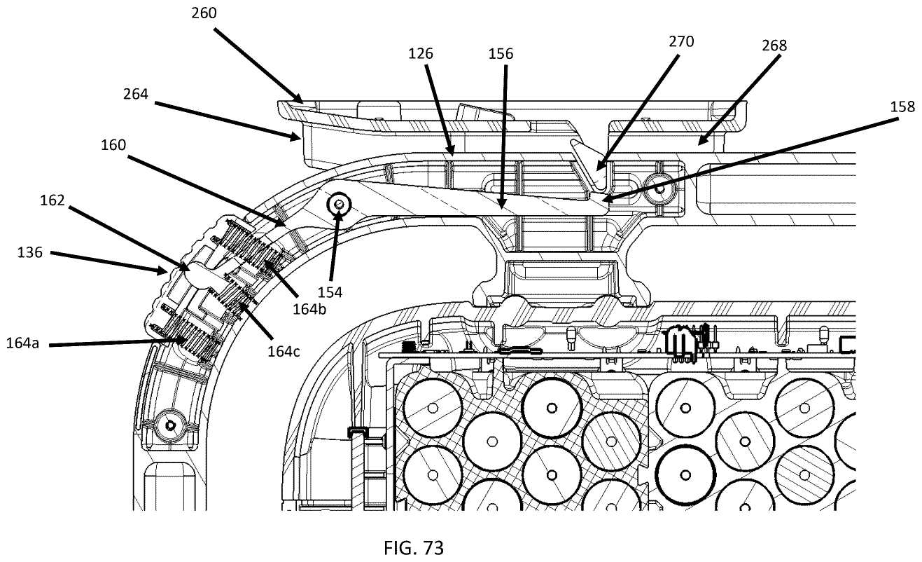

As illustrated in FIG. 73, no force is being applied to the actuation button 136 and two of the removal system springs 164a, 164b are in their expanded state pushing the actuation button 136 out of the handle 126 and a third removal system spring 164c is forcing the button engaging end 162 of the second lever arm 160 of the lever 138 to rotate about the pivot pin 154 (clockwise in the context of FIG. 73) such that the latch engaging end 158 of the first lever arm 156 is not in the catch 134 but is in the internal cavity 148 of the handle 126.

Furthermore, the springs 280 of the latching mechanism apply a force to the latch legs 272, 274 causing the latching mechanism to rotate about the pivot arms 276 (clockwise in the context of FIG. 73) such that the latch 262 (particularly, the latch cross bar member 270) is forced into the catch 134.

In other words, the latch 262 is engaged with the battery pack 110 and the battery pack 110 is latched.

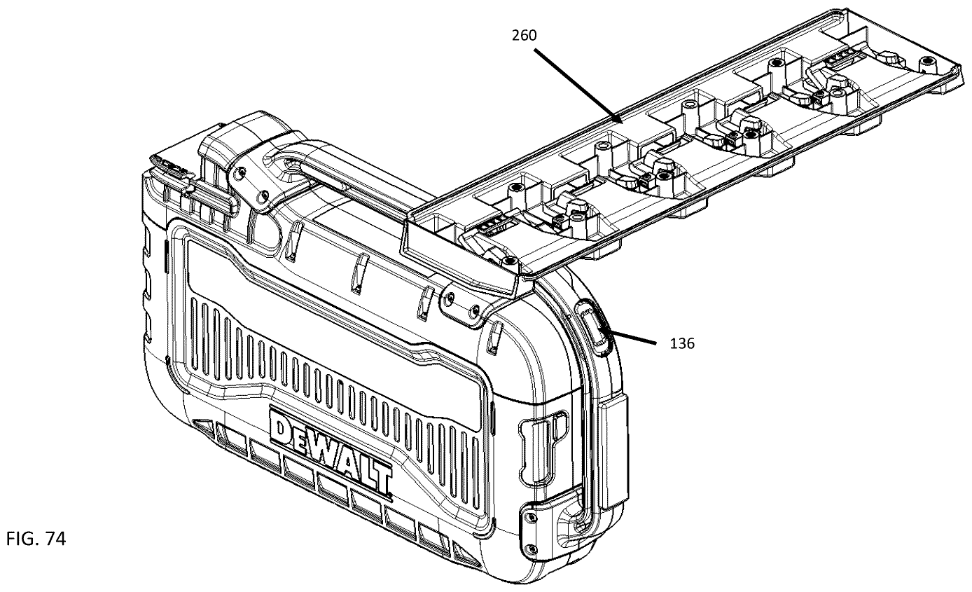

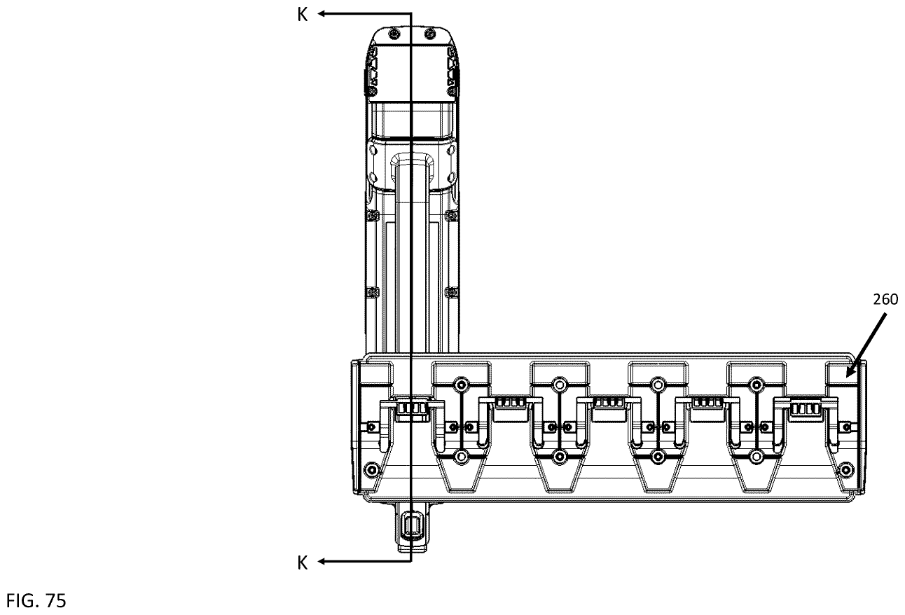

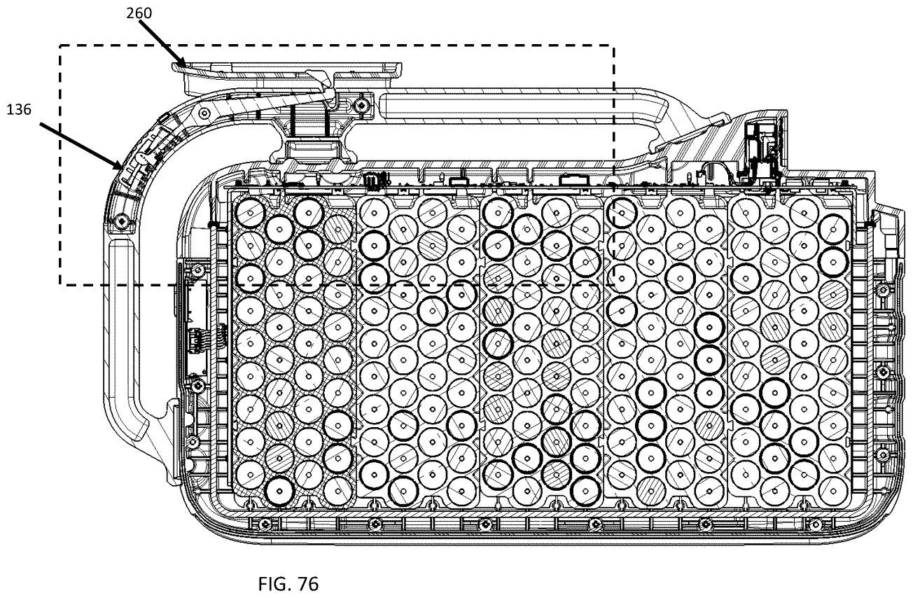

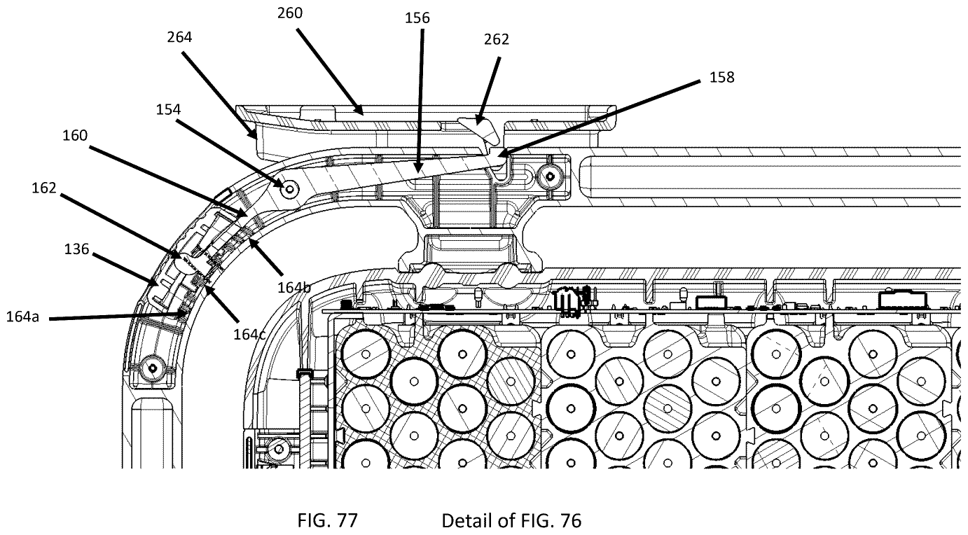

FIGS. 74-77 illustrate the example battery pack 110 in a fully coupled/mated/seated position. However, the latch 262 associated with the example battery pack 110 is in the unlatched position and the handle guidance/latching element 260 is in a removal state. In this configuration, the latch 262 associated with the battery pack 110 coupled to the lawn mower 100 is not received in the catch 134 in the battery pack handle 126. As such, the battery pack 110 is not mechanically fixed/held in the battery pack compartment 210 and may be removed from the battery pack compartment 210 by sliding the battery pack 110 in a rearward direction (to the left in the context of FIG. 77 and away from the battery pack receptacle). As illustrated in FIGS. 76 and 77, the removal system actuation button 136may be depressed (forced into the internal cavity 148 in the battery pack handle 126). By forcing the actuation button 136 into the battery pack handle 126, the button 136 compresses the springs 164, presses against the button engaging end 162 of the second lever arm 160 is forced in a first direction. As such, the lever 138 is forced to pivot (rotate-counterclockwise in the context of FIG. 77) about a pivot axis of the pivot pin 154. As such, latch engaging end 158 of the first lever arm 156 is forced in a second direction. The latch engaging end 158 of the first lever arm 156 of the lever 138 is moved into the catch 134 and engages the latch 262 forcing the latch 262 to press against the springs 280. As the lever 138 further rotates, the latch engaging end 158 of the first lever arm 156 further engages the latch and forces the latch out of the catch 134 and holding the latch 262 in the default (removal) state. As such, the latch 262 no longer holds the battery pack 110 in the battery pack compartment 210 and the battery pack 110 may be removed from the battery pack compartment 210 by sliding the battery pack 110 out of the compartment 210 along the groove 140. In other words, the latch 262 is disengaged from the battery pack 110 and the battery pack 110 is unlatched.

FIG. 78 illustrates an example electric riding lawn mower coupled to a battery pack charging station. The battery pack charging station may include a battery pack charger.

The battery pack charger may include a power supply and a power supply management module. The charging station may include a first cord for connecting/plugging into an outlet to connect the charging station to an electricity supply, such as a mains line. The mains line will provide AC power to the charging station. The charging station may convert the AC power to DC power. The charging station may include a second cord for connecting/plugging the charging station to the lawn mower. The lawn mower may include a receptacle/port for coupling to the second cord.

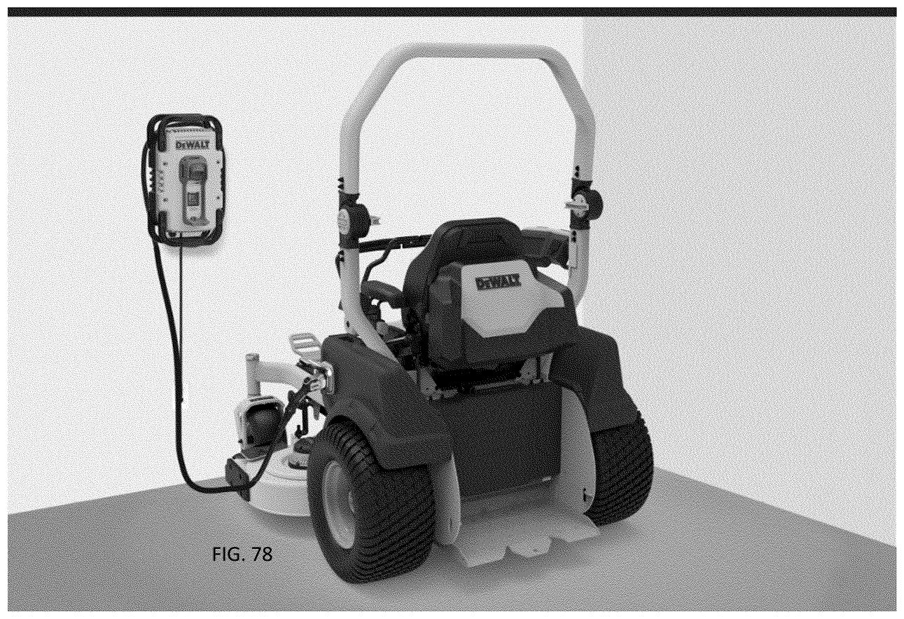

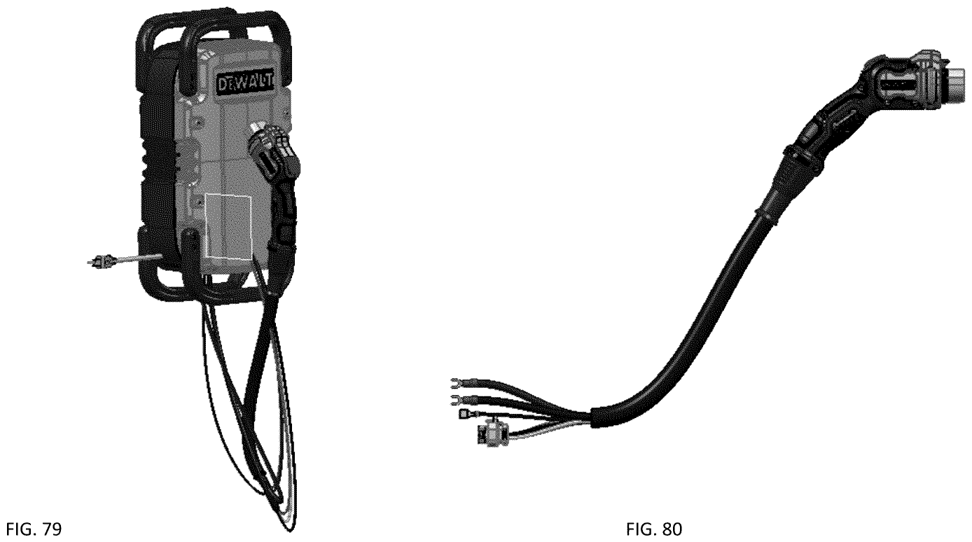

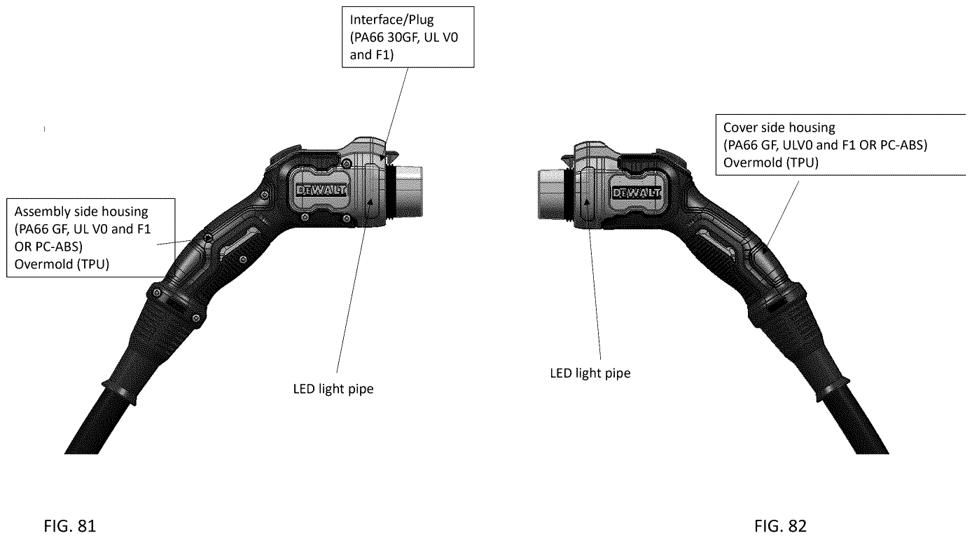

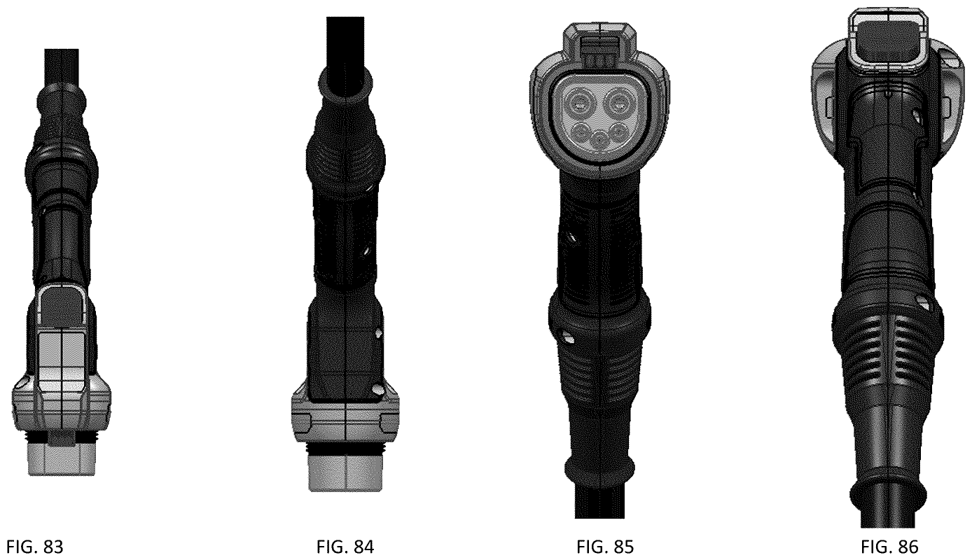

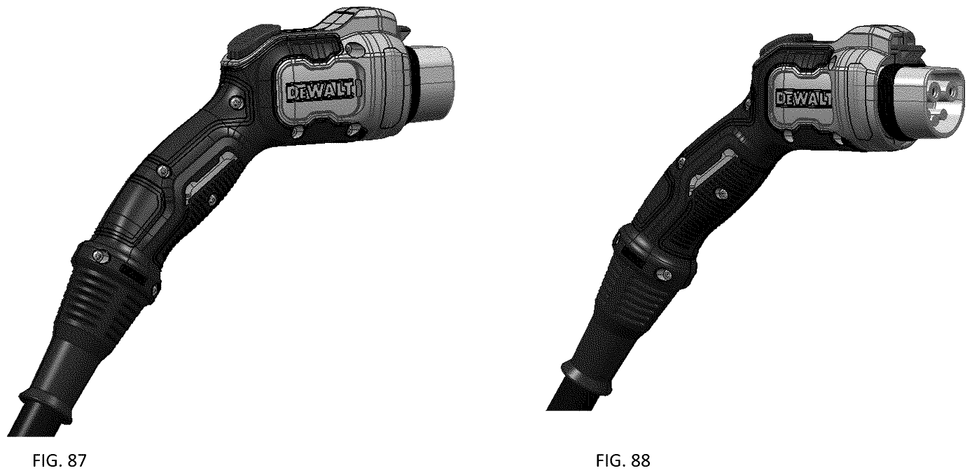

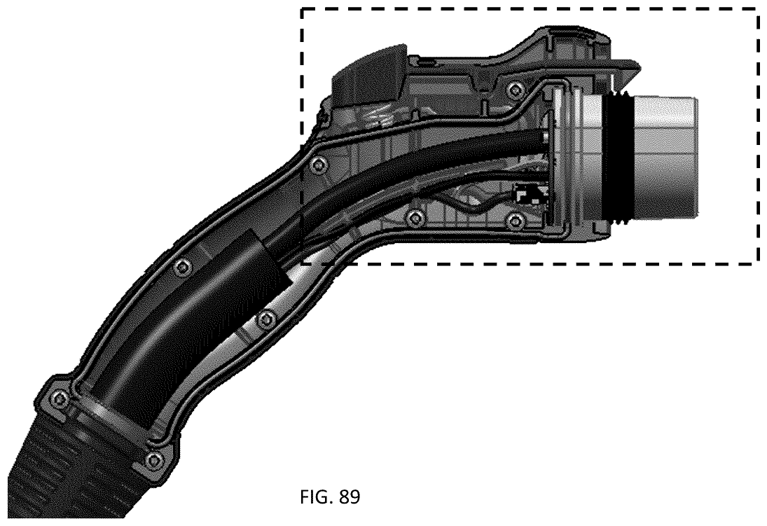

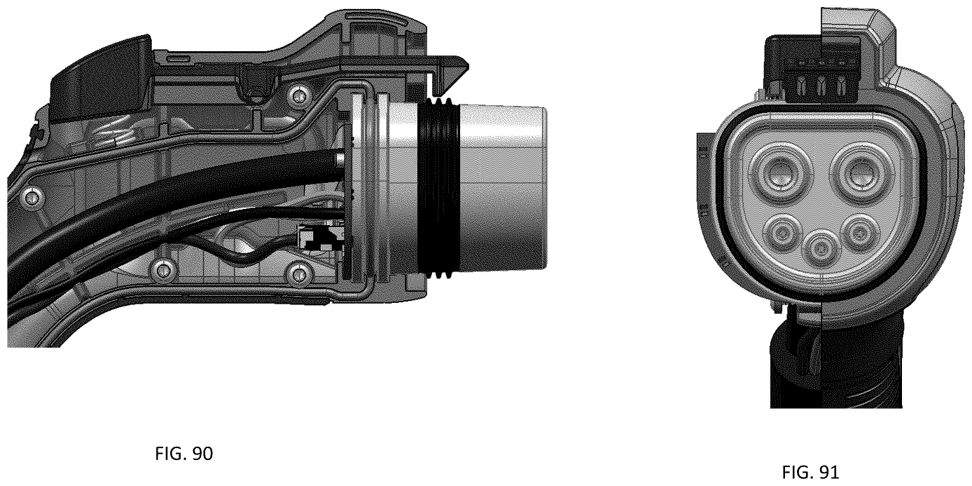

FIG. 79 illustrates the charging station. FIG. 80 illustrates an example second cord for coupling the charging station to the lawn mower. FIGS. 81-88 illustrate an example nozzle/plug/connector of the charging station. FIGS. 89-91 illustrate the example nozzle with a portion of the nozzle housing removed.

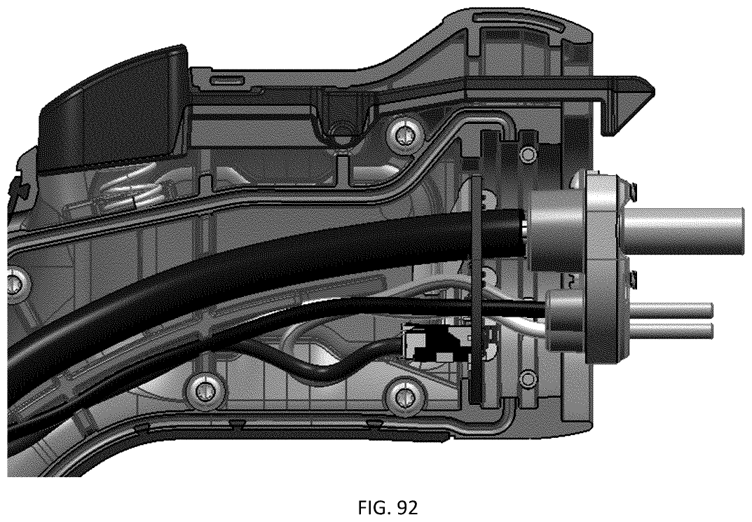

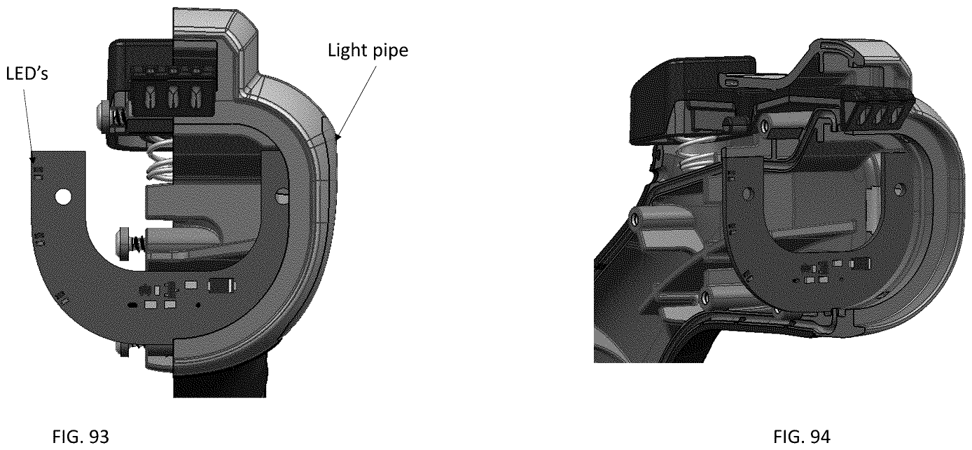

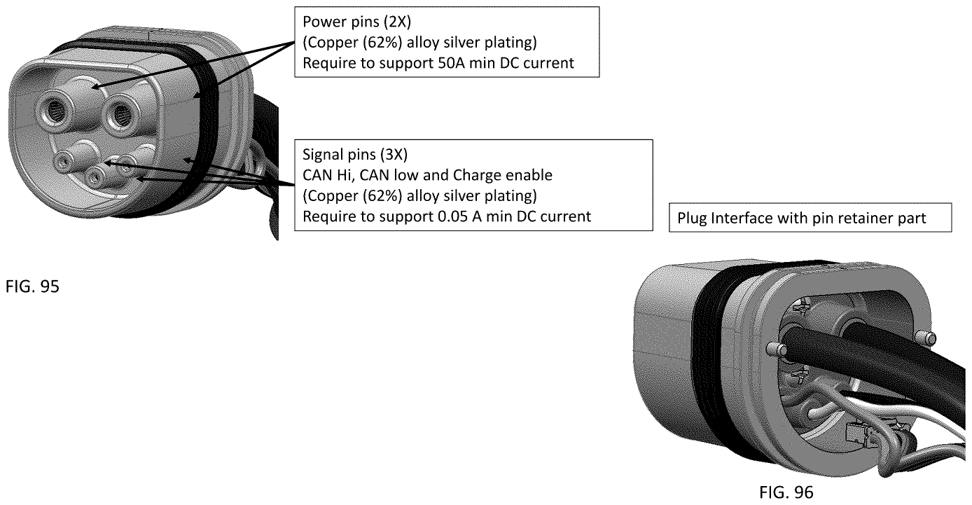

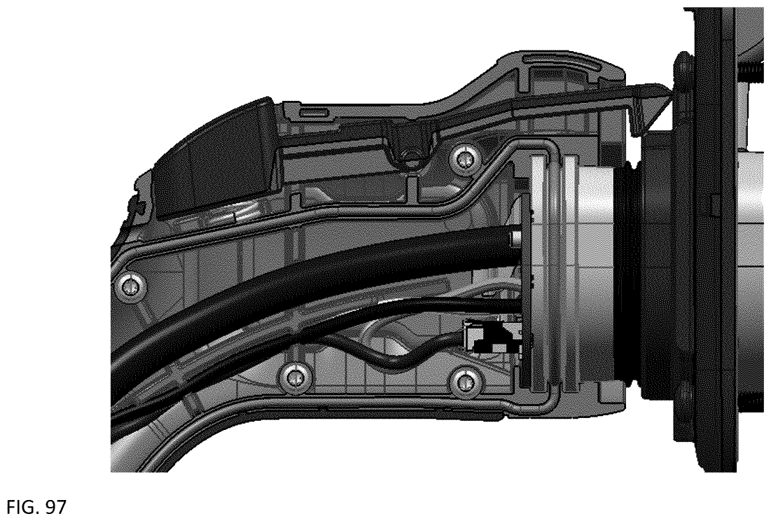

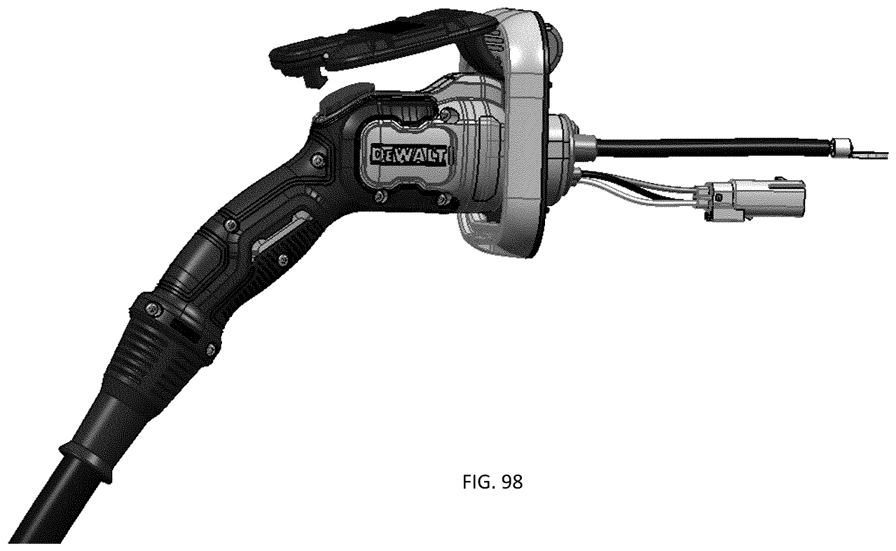

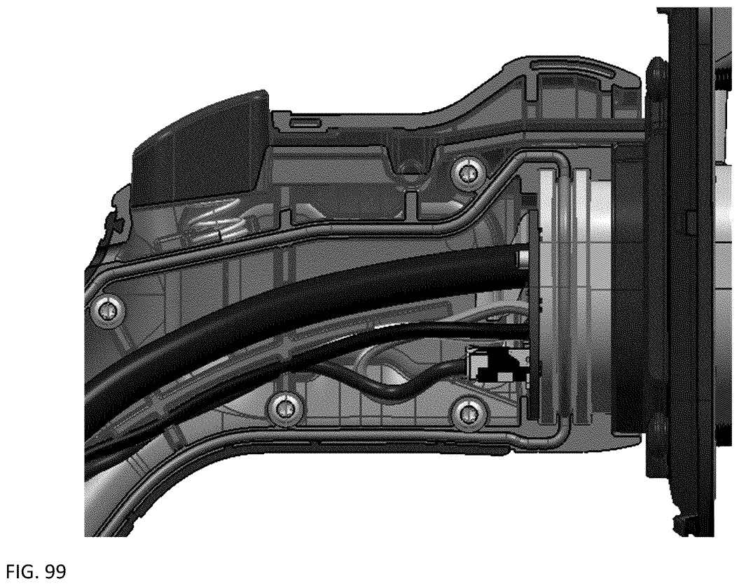

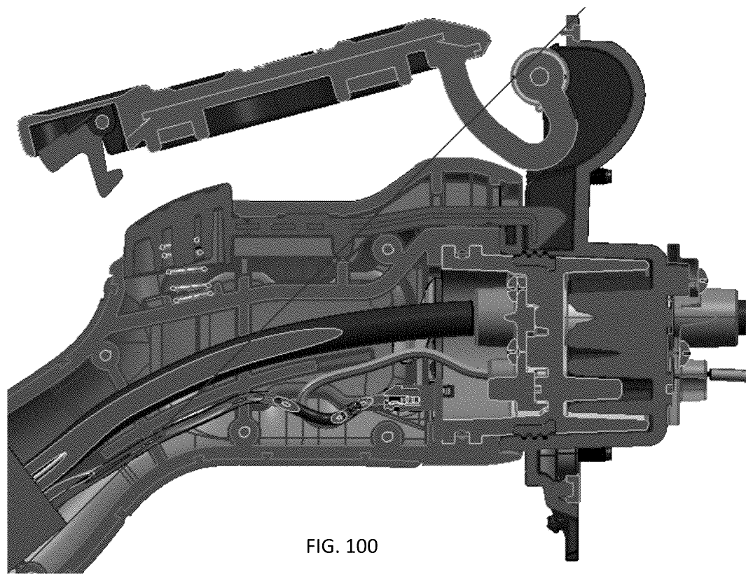

FIG. 92 illustrates the example nozzle with a plug portion of the nozzle removed. FIGS. 93 and 94 illustrate the example nozzle with the terminal/wire harness assembly removed. FIGS. 95 and 96 illustrate a portion of the terminal/wire harness assembly of the example nozzle. FIG. 97 illustrates the example nozzle just prior to mating/coupling with the receptacle of the example lawn mower. FIGS. 98-100 illustrate the example nozzle mated/coupled with the receptacle of the example lawn mower.

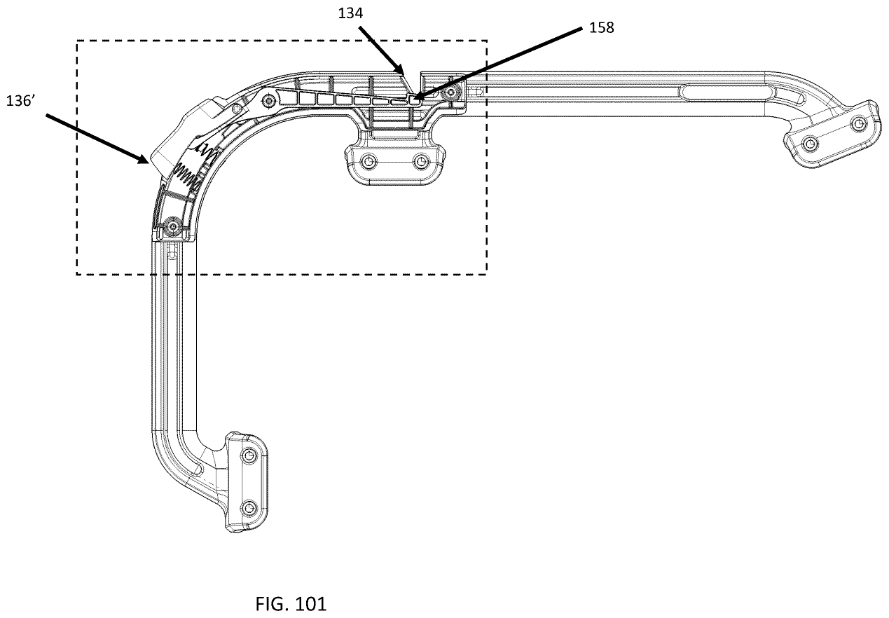

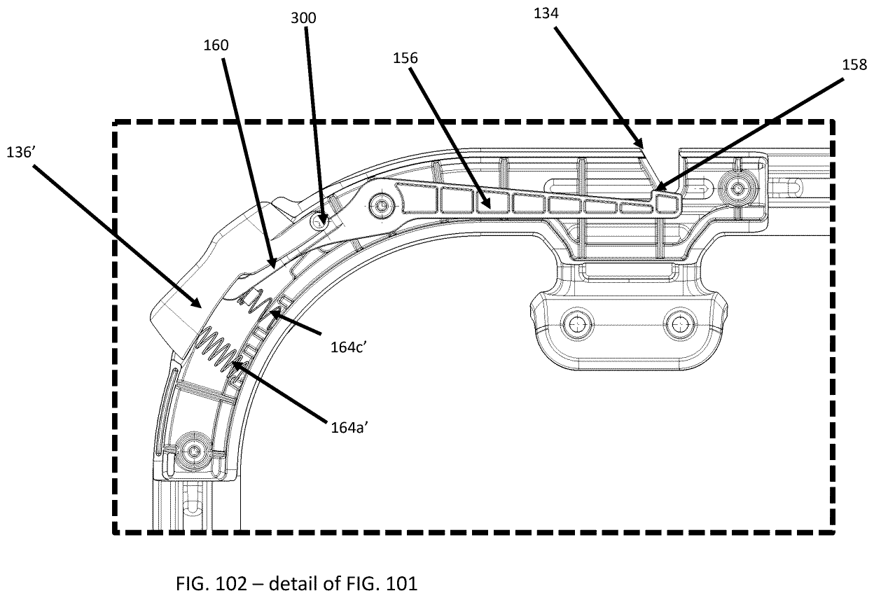

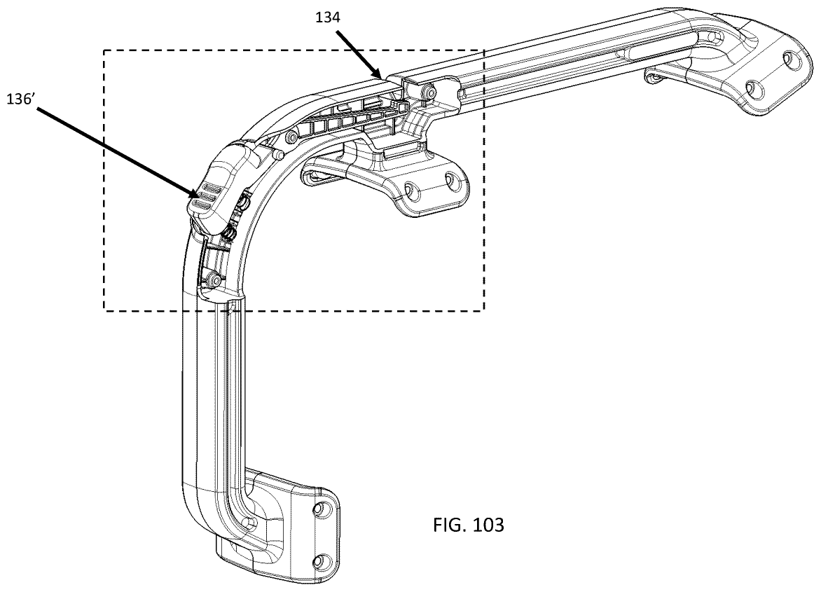

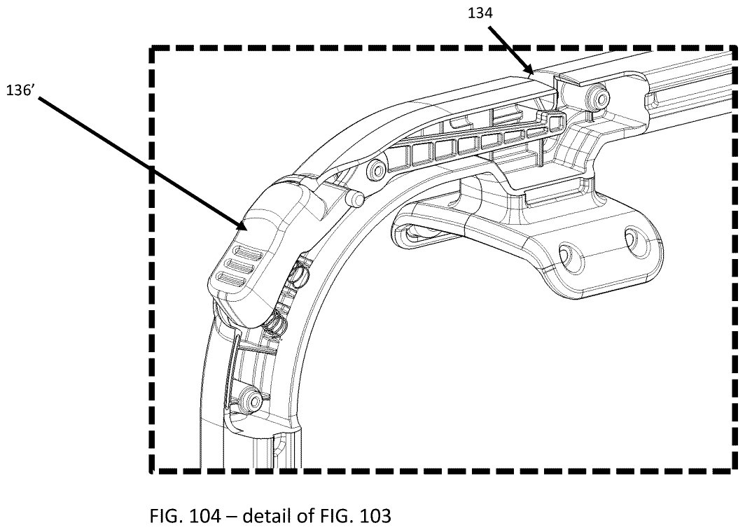

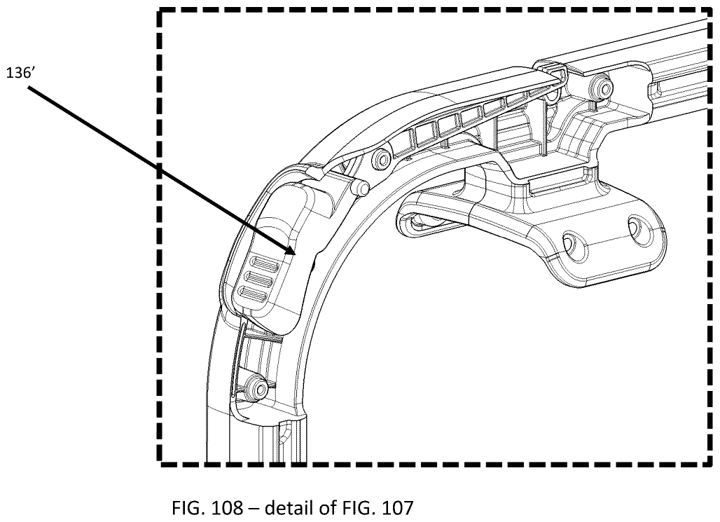

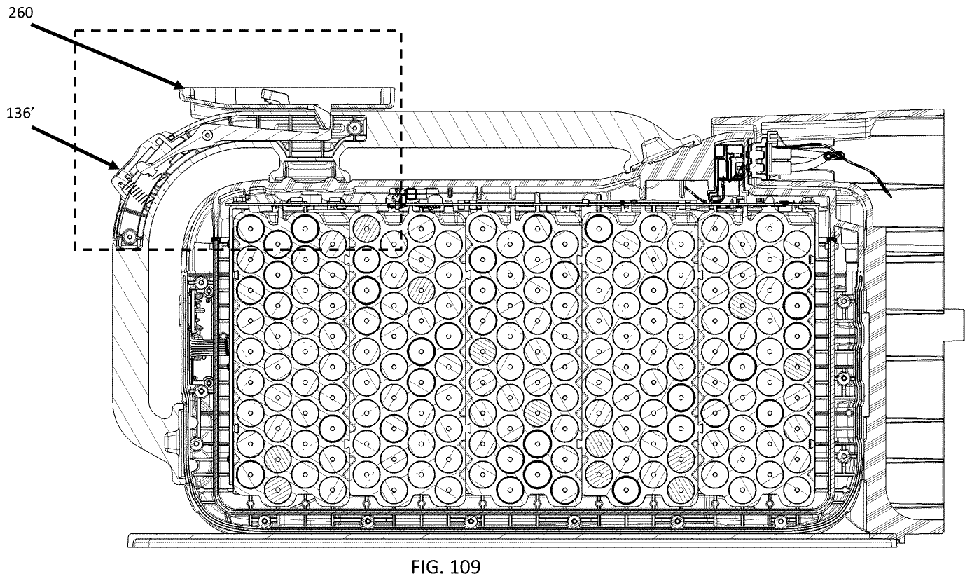

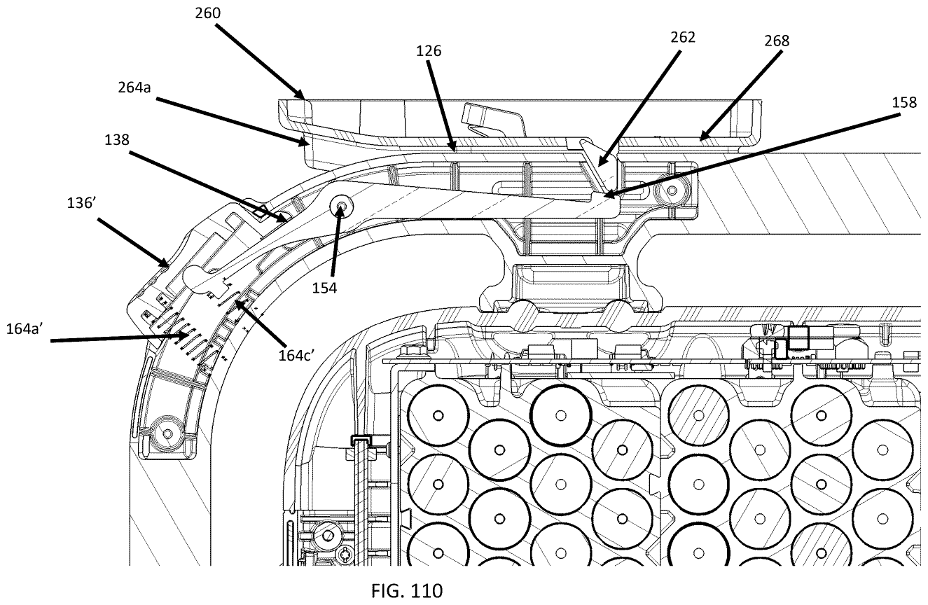

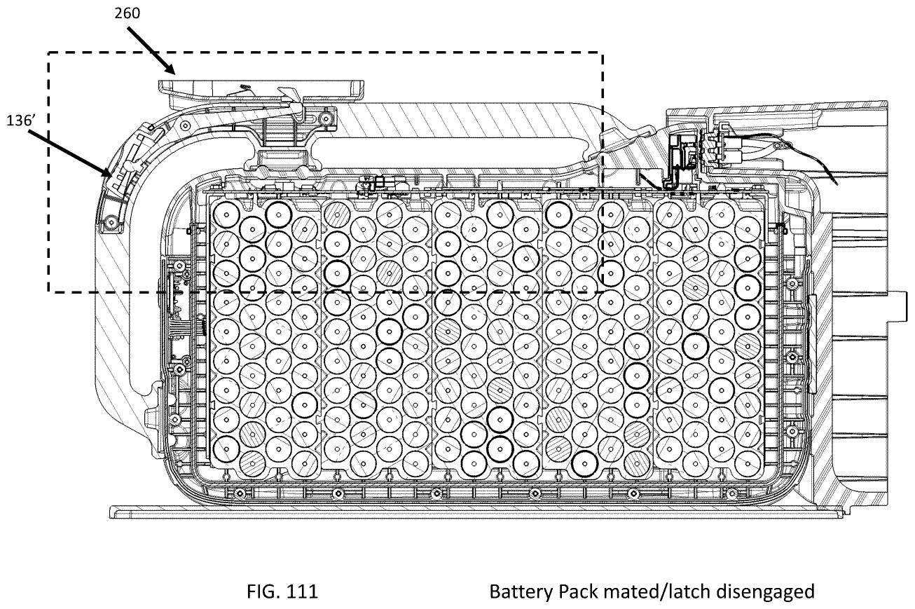

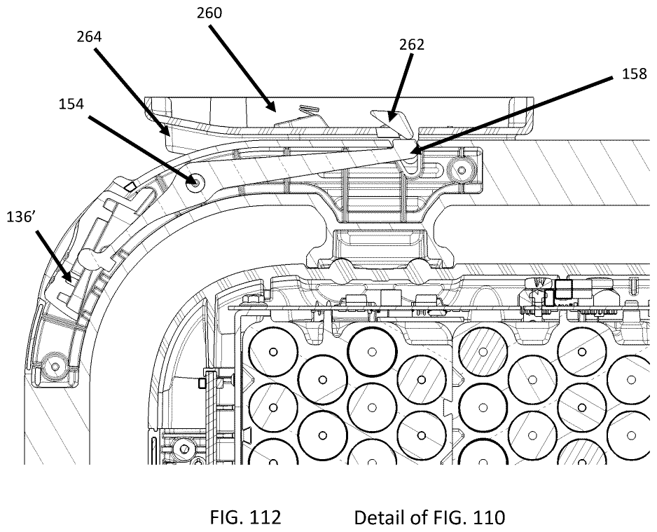

FIGS. 101-112 illustrate an alternate example embodiment of a removal system actuation button. In this example embodiment, the system may include an actuation button 136′ that is coupled to the battery handle internal cavity 148 by a pivot pin 300. Furthermore, the system may include a single coil spring 164a′ that forces the actuation button 136′ out of the handle 126. Furthermore, the system may include a second coil spring 164c′ that forces the second lever arm 160 against the actuation button 136′ and forces the lever 138 to rotate (clockwise in the context of FIGS. 101 and 102) moving/keeping the latch engaging end 158 to be in the internal cavity 148 of the handle 126.

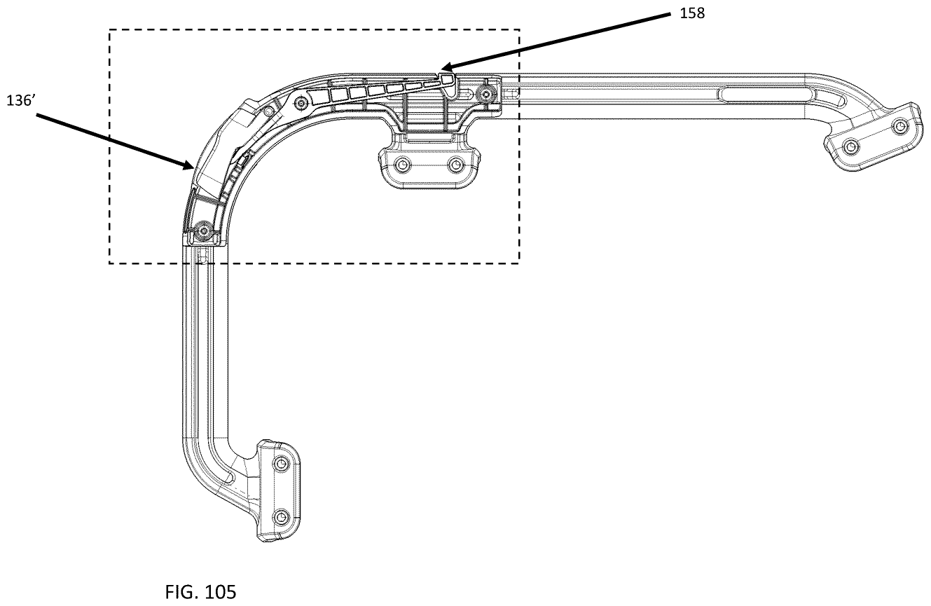

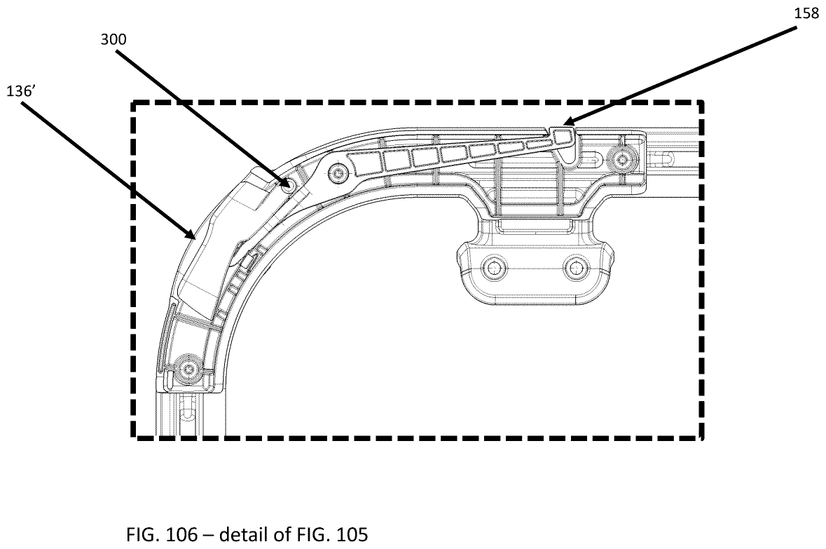

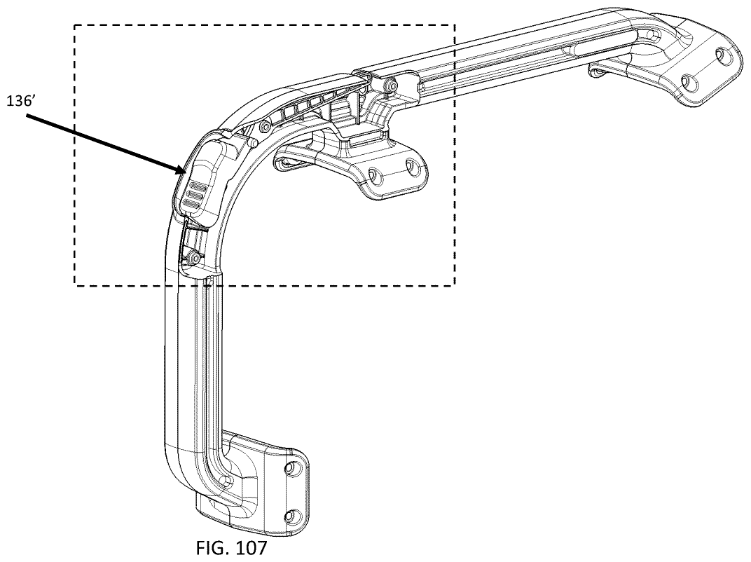

As illustrated in FIGS. 105-108, when a force is applied to the actuation button 136′ the actuation button 136′ rotates (counterclockwise in the context of FIGS. 105, 106) pressing on the second lever arm 160. This forces the lever 138 to rotate (counterclockwise in the context of FIGS. 105, 106) which moves the latching engaging end 158 of the lever 138 into the catch 134.

Otherwise, the latching system operates the same as described above.

The foregoing description illustrates the claimed invention by way of example and not by way of limitation. The description clearly enables one skilled in the art to make and use the disclosure, describes several example embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other example embodiments and of being practiced or being carried out in various ways. Also, it is to be understood that the phraseology and terminology used herein is for the purpose of description and should not be regarded as limiting.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The foregoing description of the example embodiments has been provided for purposes of illustration and description. It is not intended to be exhaustive or to limit the disclosure. Individual elements or features of a particular example embodiment are generally not limited to that particular example embodiment, but, where applicable, are interchangeable and can be used in a selected example embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough and will fully convey the scope to those who are skilled in the art. Numerous specific details are set forth such as examples of specific components, devices, and methods, to provide a thorough understanding of example embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Numerous modifications may be made to the example implementations described above. These and other implementations are within the scope of this application.

What is claimed is:

1. A battery pack, comprising:
a housing;
a handle attached to the housing;
a lever, the lever including a first arm having a latch engaging end and a second arm having an actuation button engaging end;
an actuation button positioned for engagement with the actuation button engaging end of the lever;
a catch forming an opening in the handle positioned to receive the latch engaging end of the lever.

2. The battery pack, as recited in claim 1, wherein the handle includes an internal cavity and the lever is positioned within the internal cavity.

3. The battery pack, as recited in claim 1, wherein rotation of the lever about a pivot axis moves the latch engaging end of the lever into the catch.

4. The battery pack, as recited in claim 1, further comprising an actuation button spring between an interior surface of the actuation button and an interior surface of an internal cavity of the handle that applies a force against the actuation button to move the actuation button out of the internal cavity.

5. The battery pack, as recited in claim 1, further comprising a lever spring between a surface of the actuation button engaging end of the lever and an interior surface of an internal cavity of the handle that applies a force against the actuation button engaging end of the lever to move the latch engaging end of the lever into the internal cavity.

6. The battery pack, as recited in claim 4, wherein when a force is applied to the actuation button opposed to the actuation button spring the actuation button moves into the internal cavity, the lever rotates about a pivot axis and the latch engaging end of the lever moves into the catch.

7. The battery pack, as recited in claim 1, wherein the handle is a discrete component and is attached to the housing by fasteners.

8. The battery pack, as recited in claim 1, wherein the handle is integrally formed with the housing.

9. The battery pack, as recited in claim 1, wherein the housing includes opposing sides and a bottom coupling the opposing sides and a groove on each of the opposing sides of the housing and groove on a bottom of the housing.

10. The battery pack, as recited in claim 1, wherein the handle has a generally L-shaped configuration and includes a first leg extending along a top side of the housing and a second leg extending along a rear side of the housing, wherein the first leg includes the catch.

11. A power tool and a battery pack combination, comprising:
a power tool including a compartment for receiving a battery pack, the compartment including a space generally defined by a front wall, a rear wall, a top wall, a bottom wall, a left side wall and a right side wall, wherein the battery pack is received in the compartment in a direction from the rear wall towards the front wall and the top wall includes a groove and the bottom wall includes a rail;
a battery pack including a housing, the housing including a handle on a top side and a groove on a bottom side, the handle opposed to the groove;
the handle received in the compartment groove and the compartment rail received in the battery pack groove.

12. The combination, as recited in claim 11, wherein the handle includes a catch for receiving a latch and the compartment includes a latch received in the catch.

13. The combination, as recited in claim 12, further comprising an actuation button to remove the latch from the catch.

14. The combination, as recited in claim 13, further comprising a lever positioned within the handle, the lever including a latching engaging end and an actuation button engaging end, wherein upon applying a force to the actuation button, the actuation button engages the actuation button engaging end of the lever forcing the lever to rotate about a pivot axis and forcing the latch engaging end of the lever to engage the latch and force the latch out of the catch.

15. The combination, as recited in claim 11, further comprising a handle guidance/latching element attached to the top wall, the handle guidance/latching element include a pair of rails that form the compartment groove and the latch.

16. The combination, as recited in claim 12, wherein the latch includes a crossbar member, a first leg member attached to and extending generally perpendicularly to a first end of the crossbar member and a second leg member attached to and extending generally perpendicularly to a second end of the crossbar member, wherein the first leg member and the second leg member are generally parallel to each other.

17. The combination, as recited in claim 15, wherein the latch is rotatably coupled to the handle guidance/latching element by a pair of pivot arms, wherein each pivot arm of the pair of pivot arms extends from an associated leg member presenting a pivot arm on each side of the compartment groove.

18. The combination, as recited in claim 17, wherein the pivot arms are held in place by an arm holddown that allows the latch to rotate about an axis of the pivot arm that is generally perpendicular to the leg member.

19. The combination, as recited in claim 18, further comprising a coil spring located between a handle guidance/latching element housing and a second end of each of the leg members.

20. The combination, as recited in claim 19, wherein the handle guidance/latching element housing includes an opening associated with the groove that provides passage from an inner surface of the handle guidance/latching element and an outer surface of the handle guidance/latching element.
